(19) United States
(12) Patent Application Publication
(10) Pub. No.: US 2024/0416336 A1
(43) Pub. Date: Dec. 19, 2024

(54) DEVICE FOR DETECTING ANALYTE IN FLUID SAMPLE

(71) Applicant: PREMIER BIOTECH, INC., Minneapolis, MN (US)

(72) Inventors: Todd BAILEY, Shorewood, MN (US); Liang HONG, Hangzhou (CN)

(21) Appl. No.: 18/703,518

(22) PCT Filed: Oct. 18, 2022
(86) PCT No.: PCT/IB2022/060013

§ 371 Date: Apr. 22, 2024

Related U.S. Application Data
(60) Provisional application No. 63/270,178, filed on Oct. 21, 2021.

(30) Foreign Application Priority Data
Oct. 21, 2021 (CN) 202111226003.3

(51) Int. Cl. B01L 3/00

(52) U.S. Cl. CPC B01L 3/5023; B01L 2200/0689; B01L 2200/16; B01L 2300/069; B01L 2300/14; B01L 2400/0478

(57) ABSTRACT

The present invention provides a device for detecting whether an analyte is contained in a fluid sample: the device includes an absorbing element used for absorbing the fluid sample and a testing element, and fluidic communication between the testing element and the absorbing element may be controlled. By means of such a test device, quantitative detection can be achieved, and the liquid sample on the absorbing element can be prevented from flowing onto the testing element in advance to start test at the same time. The present invention relates to an apparatus for detecting an analyte in a liquid sample, in particular, an apparatus for collecting and detecting an analyte in a liquid sample in the field of rapid diagnosis, such as a urine and saliva collection and detection apparatus.

### CROSS-REFERENCE TO RELATED APPLICATIONS

The present application claims priority to a Chinese prior application No. 202111226003.3 and filed on Oct. 21, 2021, and a US prior provisional application No. 63/270,178 and filed on Oct. 21, 2021; the entire contents of the two patent applications, including but not limited to the description, accompanying drawings, claims and abstract of which are incorporated herein as a portion of the present invention.

### TECHNICAL FIELD

The present invention relates to an apparatus for detecting an analyte in a liquid sample, in particular, an apparatus for collecting and detecting an analyte in a liquid sample in the field of rapid diagnosis, such as a urine and saliva collection and detection apparatus.

### BACKGROUND

The following description is merely an introduction to the background art and not to limit the present invention.

At present, the detection apparatus for detecting the presence or absence of an analyte in sample is widely used in hospitals or homes, and such apparatus for rapid diagnosis comprises one or more test strips, such as early pregnancy detection, drug abuse detection, etc. The apparatus is very convenient, and the detection result can be obtained from the test strip after one minute or no more than ten minutes.

The drug detection is widely used by drug control department, Public Security Bureau, drug rehabilitation centers, physical examination centers, the national conscription offices, etc. The drug detection is diverse and frequent. Some detections need to collect samples and then samples are detected in professional testing agency or testing laboratories, and some detections needs to be completed in the site in time, for example, persons who drive after drug use need to be tested on the spot (referred to as “Drug Driving”), to obtain the results in time.

For example, the detection of saliva samples is gradually accepted and favored by testing agencies or testing personnel due to convenient collection. In some literatures, various sample collection and test devices for clinical and domestic uses have been obtained and described. For example, the U.S. Pat. No. 5,376,337 discloses a saliva sampling device in which a piece of filter paper is used to collect saliva from the mouth of a subject and deliver saliva to an indicator reagent. The U.S. Pat. Nos. 5,576,009 and 5,352,410 have disclosed a syringe-type fluid sampling device.

In view of the above technical problems, it is necessary to improve them and provide an alternative approach to solve the drawbacks of the prior art.

### SUMMARY

In one aspect, the present invention provides a device for detecting whether an analyte is present in a fluid sample; the device includes a testing element, and an absorbing element used for absorbing or collecting a fluid sample, where fluidic communication between the absorbing element and the testing element is capable of being controlled.

The so-called “control” in the present application refers as follows: the testing element may be kept in fluidic communication with the absorbing element in some cases, while may be not kept in fluidic communication with the absorbing element in some other cases. Such a state of being in fluidic communication and not being in fluidic communication can be controlled, and control is relative to non-control. The control may be understood as partition, blocking, sealing, closing and the like; two elements may be not in fluidic communication with each other due to being controlled, but may be communicated in some conditions.

Such “fluidic communication” refers that liquid on the absorbing element may directly to indirectly flow onto a testing element for testing or assay. Such fluidic non-communication refers that liquid on the absorbing element may not directly to indirectly flow onto a testing element for testing or assay. In some embodiments, the absorbing element is connected to the testing element via a channel; fluid may flow through the channel to reach the testing element, for example, a liquid sample. Control refers that the channel is controlled to be an unblocked or blocked state, and may also refer to the control of a closed or opened state of the channel. In such a way, the change of state of the channel determines whether the testing element is in fluidic communication with the absorbing element or not. In some embodiments, there is not always a direct flow of liquid but an indirect flow between the absorbing element and the testing element. The so-called indirect flow refers that the absorbing element is located a space, while the testing element is located in another space, the fluidic communication between the two spaces may be controlled. In some embodiments, two spaces are connected via a channel, and the channel is provided with a controlling element to control whether the channel is communicated, closed, sealed or cut off.

In some embodiments, the control is achieved by the controlling element; when the controlling element is in the first state or in the first position, the absorbing element is not in fluidic communication with the testing element, and when the controlling element is in the second state or in the second position, the testing element is in fluidic communication with the absorbing element. In some embodiments, when the controlling element is in the first state or in the first position, the controlling element is in the closed state such that the testing element is not in fluidic communication with the absorbing element. In some embodiments, when the controlling element is in the second state or in the second position, the controlling element is in the opened state such that the testing element is in fluidic communication with the absorbing element.

In some embodiments, the controlling element automatically changes to the second state from the first state or automatically changes to the second position from the first position; or, the controlling element automatically changes to the first position or the first state from the second position or the second state. In some embodiments, the automatic change refers to the automatic change of the controlling element due to the change of the environment where the controlling element is located, for example, changing from the first state to the second state, or moving from the first position to the second position, or moving from the second position to the first position, or changing from the second state to the first state.

In some embodiments, the change of environment refers to the change of the ambient pressure, for example, an increase of gas pressure or liquid pressure. In some embodiments, the testing element and the absorbing element are separated into two different spaces or environment by the controlling element. Because there exists an air pressure difference or a liquid pressure difference between the two spaces or environment, the controlling element is automatically opened or closed; or the controlling element automatically changes from the first position to the second position, or the controlling element automatically changes from the first state to the second state. In some embodiments, the absorbing element is in a sealed space; the controlling element is used to control whether the sealed space where the absorbing element is located is in fluidic communication with the testing element or not, for example, gas circulation or fluidic communication. In some embodiments, when gas in the sealed space is compressed, gas pressure will increase such that the controlling element is opened to discharge the gas onto the testing element; or liquid in the sealed space is compressed to increase the liquid pressure such that the controlling element is opened to discharge the liquid onto the testing element. In some embodiments, the liquid herein includes a liquid sample, or a mixed solution of a liquid sample and a solution for treating the liquid sample. In some other embodiments, the testing element is in the sealed space. When pressure in the sealed space reduces or liquid pressure decreases to open the controlling element, the gas or liquid located in the absorbing element flows onto the testing element. In some embodiments, the testing element is located in a second space, and the absorbing element is located in a first sealed space; when pressure in the first sealed space increases to be higher than the pressure in the second sealed space, the controlling element will be automatically opened such that the gas or liquid located in the first sealed space flows onto the second space. In some embodiments, if it is gas, the gas is discharged to the atmospheric environment via the second space; if it is liquid, the liquid flows onto the second space to contact with the testing element. In a preferred embodiment, the second space is in fluidic communication with the atmospheric environment.

In some embodiments, the first space is connected to the second space via a channel; the controlling element includes a piston; the piston is located on the channel to achieve the fluidic communication between the testing element and the absorbing element. The piston may move in position to enable the channel to be automatically opened or closed via the position moving of the piston, thus controlling the gas or liquid exchange between the space where the absorbing element is located and the space where the testing element is located. It may be appreciable herein that fluid on the absorbing element does not directly flow onto the testing element from the absorbing element, but the gas or liquid in the sealed space where the absorbing element is located may change with the state of the controlling element, thus controllably flowing onto the testing element. It may be appreciable that the sealed space containing the absorbing element may include gas (for example, air), and may also contain a liquid sample directly released from the absorbing element due to extrusion, or a mixed eluting solution (including an eluent and sample) obtained by eluting the absorbing element with a treatment liquid, or an analyte in the liquid sample contained by eluent. In this way, when the pressure in the sealed space changes, for example, the pressure increases to be higher than that in the space where the testing element is located, the piston changes in position to control the flow of the gas or liquid in the sealed space onto the testing element.

In some embodiments, the piston moves in position automatically. In some embodiments, when there exists a pressure difference between the space where the testing element is located and the space where the absorbing element is located, and such a pressure difference refers to a gas or liquid pressure difference, the piston will be located in an opened or closed state automatically, thus controlling the fluid exchange between the space where the testing element is located and the space where the absorbing element is located. For example, gas exchange or liquid exchange; for example, gas flows to the space where the testing element is located from the space where the absorbing element is located, or liquid flows onto, e.g., the testing element from the space where the absorbing element is located. In some embodiments, when the pressure of the space where the absorbing element is located is higher than the pressure of the space where the testing element is located, the pressure enables the piston to be opened, thus opening the channel. In this way, gas or liquid in the absorbing element flows onto the testing element or the space where in the testing element is located via the channel. When the pressure of the space where the absorbing element is located is equal to the pressure of the space where the testing element is located is, the pressure difference disappears and the piston is automatically closed. In this way, the open or close is achieved automatically. To achieve being opened from being closed or being closed from being opened automatically depends on the change of the ambient pressure, which promotes the piston to be opened or closed automatically.

In some embodiments, when the piston is opened, gas or liquid in the space where the absorbing element is located may flow into the space where the testing element is located via the channel. In some embodiments, when the piston is closed, gas or liquid in the space where the absorbing element is located may not flow into the space where the testing element is located via the channel.

In some embodiments, the controlling element further includes an elastic element; the elastic element enables the piston to be in an initial closed state. It may be understood in this way that the clastic element is in a tensioning or compressed state initially, elasticity generates a rebound force to make the piston located in the initial first position or first state, and at this time, the channel is closed via the piston. When there exists a pressure difference between the space where the testing element is located and the space where the absorbing element is located, for example, when the pressure in the space where the absorbing element is located rises (relative to the space where the testing element is located), the rising pressure applies a force on the piston, and the force may overcome the rebound force such that the piston changes from the initial first position to a second position or second state of being opened. When the pressure difference disappears, or when the pressure in the space where the absorbing element is located is equal to the pressure in the space where the testing element is located, the rebound force may not be overcome, and the piston is in the closed state again under the action of a spring. By such a control way, the space where the testing element is located is in fluidic communication with or not in fluidic communication with the space where the absorbing element is located. Such a change of state may control the volume or amount of the gas or liquid in the space where the testing element is located flowing to the space where the absorbing element is located, thus achieving quantitative detection.

In some embodiments, the testing element is fixedly connected to the absorbing element. In some embodiments, the absorbing element is connected to the testing element via a rodlike object containing a channel. Fluidic communication between the testing element and the absorbing element is achieved by the channel of the rodlike object. The rodlike object is provided with the controlling element in the present invention.

In some embodiments, the space where the absorbing element is located is located in a chamber, and the space in the chamber is sealed. The device further includes a first receiving chamber for receiving the absorbing element; the chamber may be sealed, and the sealed chamber includes an absorbing element. The sealed chamber containing the absorbing element is connected to the chamber or space where the testing element is located; the channel includes the above active controlling element, or a controlling element containing a piston, or a controlling element containing a piston and a spring. In this way, if there exists a pressure difference between the sealed chamber containing the absorbing element and the chamber where the testing element is located, the controlling element is automatically opened, or the piston of the controlling element is automatically opened; when the pressure difference disappears, or there is no pressure difference, the controlling element is automatically closed, or the piston in the controlling element is closed, or automatically closed.

In some embodiments, such a pressure produce is produced automatically when the absorbing element is inserted into the first receiving chamber during detection. In some embodiments, after or when the absorbing element is inserted into the chamber, the chamber is sealed, and the absorbing element is located in the sealed chamber. In some embodiments, one end of the chamber is closed, and another end is opened; when or after the absorbing element is inserted into or enters into the chamber via the opening, the opening is sealed. In some embodiments, the collector includes an absorbing element; when the absorbing element is inserted into the chamber, the opening of the chamber is sealed by a portion of the collector or the absorbing element is in the sealed chamber. In some embodiments, when or after the absorbing element is inserted into the chamber, the chamber is sealed by a portion of the collector, or gas in the sealed chamber is compressed by a portion of the collector such that pressure in the chamber rises; or liquid in the sealed chamber is compressed such that liquid pressure rises. In some embodiments, the rising pressure, gas pressure or liquid pressure enables the position of the piston to change automatically, thus opening the piston. In this way, gas or liquid in the sealed chamber containing the absorbing element flows onto the testing element via the channel.

In some embodiments, the absorbing element is contained on the collector; the collector includes a rodlike object containing a channel; one end of the rodlike object includes an absorbing element; another end of the channel is the same as the space or chamber where the testing element is located; and one end of the channel is provided with a controlling element. In some embodiments, one end of the channel is connected to the space or chamber where the testing element is located; another end of the channel is connected to the sealed chamber containing the absorbing element; the controlling element contains a piston, or a piston and an elastic element are disposed in the channel. In initial stage, the channel is sealed by the piston. At this time, the space where the absorbing element is located is not in fluid (gas or liquid) communication with the space where the testing element is located; and there is no pressure difference between the two spaces. When there is a pressure difference between the space where the absorbing element is located and the space where the testing element is located, the pressure difference enables the piston to be opened automatically to open the channel, such that the two spaces are in fluidic communication. In some embodiments, pressure in the scaled space containing the absorbing element rises (relative to the space where the testing element is located); the piston is forced to be opened by the rising pressure (the channel is also in an opened state), such that pressure in the sealed space containing the absorbing element is discharged outside via the opened channel, for example, gas pressure or liquid pressure. The outside herein may include the space containing the testing element; the space of the testing element is communicated with the ambient atmosphere. In other words, pressure in the sealed space containing the absorbing element rises, the rise of pressure is relative to the ambient atmosphere. In this way, the rise of pressure forces the piston or the controlling element to be in different positions in the channel, such that the channel is being in an automatically opened (the rise of pressure causes a pressure difference) or being in an automatically closed state (the pressure difference disappears or there is no pressure difference between the two spaces or the pressure is the same).

In some embodiments, the device further includes a second receiving chamber; the chamber is used for receiving the first receiving chamber; where the first receiving chamber may move within the second receiving chamber and moves from the first position to the second position. The first receiving chamber moves within the second receiving chamber to increase the pressure of the chamber containing the absorbing element. The second receiving chamber includes a closed end and an opened end; the first receiving chamber is located in the second receiving chamber and seals the opening of the second receiving chamber. In this way, the absorbing element is located in the first chamber, and the first chamber is also located in another second sealed chamber; the first chamber is in fluidic communication with the second sealed chamber. In this way, pressure in the second sealed chamber rises to increase the pressure in the first chamber. In such an embodiment, the first receiving chamber may be opened on one end, and another end is sealed by a portion of the collector. The scaled chamber contains an absorbing element; the sealed chamber is located another scaled chamber. If another sealed chamber is compressed by air, it is inevitably to cause the rise of the pressure in the first sealed chamber. Therefore, it may be understood from the above embodiments that the so-called sealed space includes two ways, one way is as follows: for example, the opening of the first receiving chamber is sealed to form a sealed space in the first receiving chamber by itself; and the second way is as follows: if the first receiving chamber is not scaled by itself (for example, one end is opened), but the first receiving chamber is located another sealed space, for example, in the sealed space of the second receiving chamber. In this way, when gas in the second sealed space is compressed, gas in the first space will be inevitably compressed to cause the rise of pressure.

In some embodiments, the first receiving chamber includes a piercing element; the second receiving chamber includes a sealed chamber containing a sample treatment liquid; the piercing element may pierce the chamber of the treatment liquid to release the treatment liquid, and then the liquid enters into the first receiving chamber to contact the absorbing element located in the first scaled chamber.

In another aspect, the present invention provides a method for detecting an analyte in a sample. The method includes a step of providing a test device; the device includes an absorbing element for absorbing a sample and a testing element for detecting whether an analyte is detected in the sample; fluidic communication between the absorbing element and the testing element is controlled by a controlling element. When the controlling element is opened, the absorbing element is in fluidic communication with the testing element; when the controlling element is closed, the absorbing element is not in fluidic communication with the testing element.

In some embodiments, the absorbing element is located in the sealed space, and the testing element is located in another space, and a controlling element is disposed between the two spaces. When pressure in the sealed space containing the absorbing element rises, the rising pressure enables the controlling element to be opened such that the absorbing element is in fluidic communication with the testing element. In some embodiments, when pressure in the sealed space containing the absorbing element reduces, or reduces to be equal to that in the space where the testing element is located, the controlling element automatically returns to the closed state from the opened state, such that the absorbing element is not in fluidic communication with the testing element. In some embodiments, the rise of pressure includes the rise of pressure as gas in the scaled space is compressed, or liquid in the sealed space is compressed.

In some embodiments, the absorbing element is located in a sealed chamber to increase the pressure in the chamber. The rising pressure forces the piston to achieve the position change such that gas or liquid in the sealed chamber flows into the space where the testing element is located to contact the testing element. In some embodiments, a first receiving chamber for receiving an absorbing element is provided; one end of the chamber is closed, and another end is opened such that the collector containing the absorbing element is inserted into the first receiving chamber. Therefore, the opening is sealed by a portion of the collector such that the absorbing element is located in the sealed chamber.

In some other embodiments, a second receiving chamber is provided; the second receiving chamber includes a closed end and an opened end. The first receiving chamber is located in the second receiving chamber such that the first receiving chamber seals the opening of the second receiving chamber to form a sealed space in the second receiving chamber. In this way, the sealed space in the second receiving chamber may be in fluidic communication with the space of the first chamber; gas in the second receiving chamber is compressed to increase the pressure in the first sealed chamber. In this way, the rising pressure enables the piston to change from the initial closed state into an automatically opened state, such that gas in the sealed space flows via the channel for connecting the absorbing element to the chamber where the testing element is located. When the scaled space contains liquid, the liquid flows into the chamber where the testing element is located from the sealed space containing the testing element, thus being in contact with the testing element. Liquid herein may include a liquid sample.

### Beneficial Effects

A detection of higher sensitivity can be achieved with the foregoing structure. Moreover, the detachable combination of absorbing element and testing element reduces the assembly cost and reduce the damage to the testing element by different treatments. Moreover, the absorbing element is in controllable fluidic communication with the testing element, which may avoid that the fluid sample on the absorbing element flows onto the testing element not in detection and assay process, thereby initiating the detection in advance; further, when the fluid sample is mixed with the mixed solution, the mixing with the mixed solution or the mixing in a compressed state may be controlled, thus controlling the flowing opportunity of liquid and improving the controllability of the assay process. Moreover, the quantitative detection a sample may be also achieved.

### BRIEF DESCRIPTION OF DRAWINGS

FIG. 1 is an explosive diagram showing a three-dimensional state of a test device in a detailed embodiment of the present invention, and shows combining forms of each functional element of the test device;

FIG. 2 is an explosive structure diagram of a collector in a detailed embodiment of the present invention, and shows detailed structures and position relations of an absorbing element and a controlling element;

FIG. 3 is a schematic diagram showing a three-dimensional structure of a controlling element in a detailed embodiment of the present invention, contains a piston and an clastic element (spring) and a base used in combination with the piston;

FIG. 4A shows a position relation diagram of a controlling element and an absorbing element in a detailed embodiment of the present invention; the section shows an assembled structure diagram; FIG. 4B is a schematic diagram showing an assembled structure of the absorbing and a collector; FIG. 4C is a structure breakdown diagram showing how the absorbing element is assembled to an end portion of a collector by a fixed structure;

FIG. 5A is a structure diagram of a piston chamber; FIG. B is a structure diagram of a piston; FIG. 5C is a structure diagram after the piston is combined with the piston chamber (the piston is in the initial state or first position, or a closed state); FIG. 5D is a schematic diagram of a structure principle showing that the piston is in an opened state under pressure such that the outside liquid or gas flows into the channel via the piston chamber; FIG. 5E is a schematic diagram of a structure principle showing that when pressure is balanced or not higher than the counter-acting force of a spring, the piston returns to the initial closed state;

FIG. 6 is a diagram showing a specific structure of a controlling element between the testing element and the absorbing element in a detailed embodiment;

FIG. 7 is a schematic diagram showing a specific structure of a second receiving chamber in a detailed embodiment of the present invention;

FIG. 8 is a schematic diagram showing a three-dimensional breakdown structure of a first receiving chamber and a second receiving chamber in a detailed embodiment;

FIG. 9 is a schematic diagram showing a sectional structure of an assembled structure of a first receiving chamber and a second receiving chamber in a detailed embodiment, where the first receiving chamber seals the opening of the second receiving chamber to form a second scaled chamber in the second receiving chamber;

FIG. 10 is a schematic diagram showing a three-dimensional structure of a first receiving chamber and a second receiving chamber in another detailed embodiment of the present invention;

FIG. 11 shows a schematic diagram showing a three-dimensional structure assembled by a collector and a carrier;

FIG. 12A is a schematic diagram showing that the test device containing a controlling element is inserted into the initial position of the first receiving chamber; FIG. 12B is a sectional structure showing that an absorbing element of the test device in FIG. 12A is to be inserted into the first receiving chamber in the initial state;

FIG. 13 is a schematic diagram of a position structure showing that an absorbing element on a testing element is located in a first receiving device and the absorbing element is sealed in a first receiving chamber (a first chamber) (the absorbing element is not compressed) in a detailed embodiment of the present invention, where the second sealed chamber is not compressed either; the second sealed chamber is in fluidic communication with the first chamber, and at this time, the piston is located in a closed first position;

FIG. 14 shows that in a detailed embodiment of the present invention, the absorbing element is compressed, and the volume of the first chamber is compressed (pressure rises or increases); the second sealed chamber is also compressed, and liquid in the chamber containing a treatment liquid in the second sealed chamber is released to the first chamber to contact with the absorbing element; the rising pressure enables the piston to move from the closed initial position to the opened position; liquid flows out of the channel controlled by the piston and flows into the space or chamber where the testing element is located to contact the testing element;

FIG. 15 shows that in a detailed embodiment of the present invention, after the absorbing element is compressed, the first sealed chamber is compressed in volume, and the second sealed chamber is also compressed, and pressure in the sealed chamber is balanced with or equal to the pressure in the chamber where testing element is located, the controlling element returns to the initial closed position and the channel is closed, and gas or liquid in the sealed space containing the absorbing element may not flow into the space where the testing element is located;

FIG. 16 is a schematic diagram showing a three-dimensional structure of a carrier bearing the testing element; the carrier is formed to accommodate the space of the testing element; in the space, testing element is accommodated by a groove, and testing element is covered by a transparent film;

FIG. 17 is a structure diagram showing a carrier in another detailed embodiment;

FIG. 18 is an enlarged diagram showing a local structure of a portion A of the carrier shown in FIG. 17;

FIG. 19 is a schematic diagram showing a back structure of the carrier.

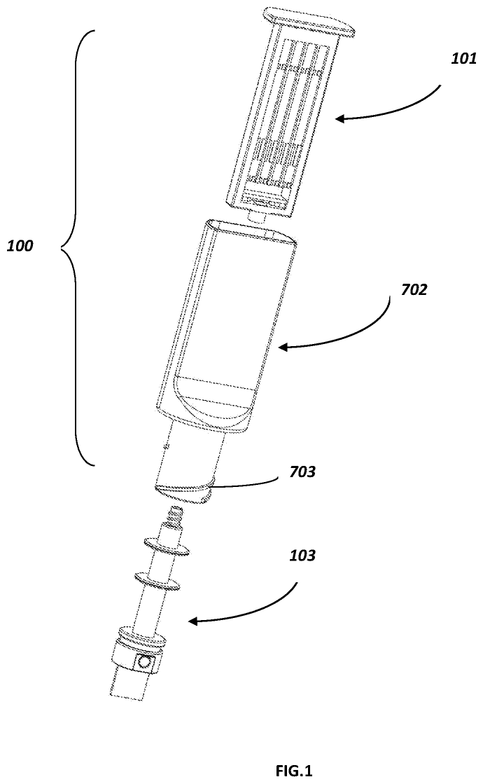

### DETAILED DESCRIPTION OF EMBODIMENTS

The structures or technical terms used in the present invention are further described in the following. Unless otherwise indicated, they are understood or interpreted according to ordinary terms and definitions in the art.

### Detection

Detection denotes assaying or testing whether a substance or material exists, for example, but not limited to, chemicals, organic compounds, inorganic compounds, metabolites, drugs or drug metabolites, organic tissues or metabolites of organic tissues, nucleic acid, proteins or polymers. Moreover, detection denotes testing the number of a substance or material. Further, assay also denotes immunoassay, chemical detection, enzyme detection and the like.

### Samples

The samples that can be detected by the detection apparatus or samples collected in the present invention include biological liquid (e.g., case liquid or clinical samples). These samples or specimens can be derived from solid or semi-solid samples, including fecal materials, biological tissues and food samples. Solid or semi-solid samples can be converted to liquid samples using any appropriate method, such as mixing, crushing, macerating, incubating, dissolving or digesting the solid samples in a suitable solution (such as water, phosphate solution or other buffer solutions) with the enzymolysis. “Biological samples” include samples from animals, plants and food, for example, including urine, saliva, blood and components thereof, spinal fluid, vaginal secretion, semen, faeces, sweat, secreta, tissues, organs, tumors, cultures of tissues and organs, cell culture and medium from human or animals. The preferred biological sample is urine, preferably, the biological sample is saliva. Food samples comprise food processed substances, final products, meat, cheese, liquor, milk and drinking water; and plant samples comprise samples from any plants, plant tissues, plant cell cultures and media. “Environmental samples” are derived from the environment (for example, liquid samples, wastewater samples, soil texture samples, underground water, seawater and effluent samples from lakes and other water bodies). Environmental samples may further include sewage or other waste water. These samples are usually used for detecting the presence or absence of an analyte.

Any analyte can be detected using the appropriate detecting element or testing element of the present invention. Preferably, the present invention is used to detect small drug molecules in saliva and urines. Of course, any form of samples, either initially solid or liquid, can be collected by the collection device or collector in the present invention, as long as the liquid or liquid samples can be absorbed by the absorbing element 20. The absorbing element 20 is generally prepared from a water absorbent material and is initially dry. It can absorb liquid or fluid specimens by capillary or other characteristics of the absorbing element material. The absorbent material can be made from any liquid absorbing material such as sponge, filter paper, polyester fiber, gel, non-woven fabric, cotton, polyester film, yarn, etc. Of course, the absorbing element is not necessarily prepared by an absorbent material but may be prepared by a non-water absorbent material. But the absorbing element has pores, threads, and cavities and liquid specimens may be collected on these structures. These samples are generally solid or semi-solid samples, and these samples are filled in the threads, cavities or pores. In this way, even though these samples cannot be squeezed or compressed, can be treated by a sample treatment liquid and thus, and can be also utilized in the detailed embodiments of the present invention.

### Downstream and Upstream

Downstream and upstream are divided according to the flow direction of liquid, and generally, liquid flows from upstream to downstream regions. The downstream region receives liquid from the upstream region, and also, liquid can flow to the downstream region along the upstream region. Here the regions are often divided according to the flow direction of liquid. For example, on some materials that use capillary force to promote liquid to flow, liquid can flow against the gravity direction, at this time, the upstream and downstream regions are still divided according to the flow direction of liquid. For example, in the test device of the present invention, when the absorbing element 20 absorbs a fluid sample or a specimen, the fluid may indirectly flow to the sample application area 1121 of the testing element 112 from the absorbing element. At this time, liquid in the sample application area 1121 flows from the upstream to the downstream of the absorption area 1123. During the process of flow, liquid flows through the testing area 1122, and the testing area is provided with a testing area 1125 and a test result control area 1124. The testing area may be a polyester fiber film and the sample application area may be a glass fiber. At this time, the absorbing element 20 is located at the upstream of the loading area 1121 of the testing element. When the test device is vertically inserted into the first receiving chamber, the absorbing element is compressed to release a liquid sample; the liquid sample flows through the piston and flows onto the testing element along the channel; the absorbing element is located at the upstream of the controlling element; the piston is located at the downstream of the absorbing element, and the testing element is located at the downstream of the controlling element. The inventor will specify how the liquid flows in combination with detailed embodiments below, and particularly specify how the liquid communication is passive and controlled in combination with the present invention.

### Gas Flow or Liquid Flow

Gas flow or liquid flow means that liquid or gas can flow from one place to another place. The flow process may pass through some physical structures, to play a guiding role. The “passing through some physical structures” here means that liquid passes through the surface of these physical structures or their internal space and flows to another place passively or actively, where passivity is usually caused by external forces, such as the flow of the capillary action. The flow here may mean flow of gas or liquid due to self-action (gravity or pressure), or passive flow, flow towards the opposite direction of gravity after overcoming gravity. Here, the communication does not mean that a liquid or a gas is necessarily present, but indicates a relationship or state between two objects under some circumstances. In case of presence of liquid, it can flow from one object (passive or active) to another, or flow from one space to another. Here it means the state in which two objects are connected. In contrast, if there exists no gas flow or liquid flow state between two objects, and liquid exists in or above one object but cannot flow into or on another object, it is a non-flow, non-liquid or non-gas flow state. Therefore, liquid communication or gas communication refers to gas or liquid exchange between two different spaces. In this present invention, liquid or gas exchange between the two spaces is controlled. In some embodiments, the pressure difference between two spaces will enable the controlling element to be in an opened or closed state automatically, thus achieving the automatic fluidic communication or non-communication between the two spaces.

### Detachable Combination

A detachable combination means that the connection relationship of two parts is in several different states or locations, for example, when two physical parts are separated initially, they can connect or combine together at an appropriate first condition; and at an appropriate second condition, the two parts can be separated, and the separation is a separation of physical space, without contact. Or, the two parts are combined together initially, and when appropriate, the two parts can be separated physically, or two objects are separated initially, and when required, they combine together to complete some functions, and then separate, or combine again for some purposes subsequently. In a word, the combination or separation of two parts is easy, and such combination or separation can be repeated for many times, of course, it can be one-time combination or separation. In addition, the combination may be a detachable combination between two parts, or a mutually detachable combination between three or more parts, for example, with three parts, the first part is detachably combined with the second part, and the second part can also be detachably combined with the third part, and the first part can also be detachably combined with or separated from the third part. Moreover, the combination between them can be achieved by two detachable objects or indirectly through another object. Here, the collector 103 with the absorbing element 20 may be detachably combined with the carrier with the testing element (as shown in FIG. 11). The detachable combination can be in a direct or an indirect way, as described in details below. The carrier 101 that accommodates testing is also detachably combined with the chamber 702 that receives the carrier, such that they are combined to form a detection apparatus, but after disassembly, they may each have their own purposes. In the present invention, after the collector 103 with the absorbing element 20 is separated from the testing element, the absorbing element can be separately sterilized, such as sterilization by high temperature. X-ray, radiation, etc. After the sterilization, the absorbing element is combined with the testing element. By this way, the absorbing element can be brought into fluidic communication with the testing element such that the liquid from the absorbing element can flow from the absorbing element to the testing element.

### Testing Element

The “testing element” used herein refers to an element that can be used to detect whether a sample or a specimen contains an interested analyte. Such testing can be based on any technical principles, such as immunology, chemistry, electricity, optics, molecular science, nucleic acids, physics, etc. The testing element can be a lateral flow test strip that can detect a variety of analytes. Of course, other suitable testing elements can also be used in the present invention.

Various testing elements can be combined for use in the present invention. One form of the testing elements is test paper. The test papers used for analyzing the analyte (such as drugs or metabolites that show physical conditions) in samples can be of various forms such as immunoassay or chemical analysis. The analysis mode of non-competition law or competition law can be adopted for test papers. A test paper generally contains a water absorbent material that has a sample application area, a reagent area and a testing area. Samples are added to the sample application area and flow to the reagent area through capillary action. If analyte exists in the reagent area, samples will bind to the reagent. Then, samples continue to flow to the testing area. Other reagents such as molecules that specifically bind to analyte are fixed in the testing area. These reagents react with the analyte (if any) in the sample and bind to the analyte in this area, or bind to a reagent in the reagent area. Marker used to display the detection signal exists in the reagent area or the detached mark area.

Typical non-competition law analysis mode: if a sample contains analyte, a signal will be generated; and if not, no signal will be generated. Competition law: if no analyte exists in the sample, a signal will be generated; and if analyte exists, no signal will be generated.

The testing element can be a test paper, which can be water absorbent or non-absorbing materials. The test paper can contain several materials used for delivery of liquid samples. One material can cover the other material. For example, the filter paper covers the nitrocellulose membrane. One area of the test paper can be of one or more materials, and the other area uses one or more other different materials. The test paper can stick to a certain support or on a hard surface for improving the strength of holding the test paper.

Analyte is detected through the signal generating system. For example, one or more enzymes that specifically react with this analyte is or are used, and the above method of fixing the specifically bound substance on the test paper is used to fix the combination of one or more signal generating systems in the analyte testing area of the test paper. The substance that generates a signal can be in the sample application area, the reagent area or the testing area, or on the whole test paper, and one or more materials of the test paper can be filled with this substance. The solution containing a signifier is added onto the surface of the test paper, or one or more materials of the test paper is or are immersed in a signifier-containing solution, and the test paper containing the signifier solution is made dry.

Each area of the test paper can be arranged in the following way: sample application area, reagent area, testing area, control area, area determining whether the sample is adulterated, and liquid sample absorbing area. The control area is located behind the testing area. All areas can be arranged on a test paper that is only made of one material. Also, different areas may be made of different materials. Each area can directly contact the liquid sample, or different areas are arranged according to the flow direction of liquid sample; and a tail end of each area is connected and overlapped with the front end of the other area. Materials used can be those with good water absorption such as filter papers, glass fibers or nitrocellulose membranes. The test paper can also be in the other forms.

The nitrocellulose membrane test strip is commonly used, that is, the testing area includes a nitrocellulose membrane on which a specific binding molecule is fixed to display the detecting result; and other test strips such as cellulose acetate membrane or nylon membrane test strips can also be used. For example, the test strips and similar apparatuses with test strips disclosed in the following patents can be applied to the testing elements or detection apparatuses in this invention for analyte detection, such as the detection of the analyte in the samples: U.S. Pat. Nos. 4,857,453; 5,073,484; 5,119,831; 5,185,127; 5,275,785; 5,416,000; 5,504,013; 5,602,040; 5,622,871; 5,654,162; 5,656,503; 5,686,315; 5,766,961; 5,770,460; 5,916,815; 5,976,895; 6,248,598; 6,140,136; 6,187,269; 6,187,598; 6,228,660; 6,235,241; 6,306,642; 6,352,862; 6,372,515; 6,379,620, and 6,403,383 The test strips and similar device provided with a test strip disclosed in the above patent literatures may be applied in the testing element or detecting apparatus of the present invention for the detection of an analyte, for example, the detection of an analyte in a sample.

The test strips used in the present invention may be those what we commonly called lateral flow test strip, whose specific structure and detection principle are well known by those with ordinary skill in the art. Common test strip includes a sample collecting area or a sample application area, a labeled area, a testing area and a water absorbing area; the sample collecting area includes a sample receiving pad, the labeled area includes a labeled pad, the water absorbing area may include a water absorbing pad; where the testing area includes necessary chemical substances for detecting the presence or absence of analyte, such as immunoreagents or enzyme chemical reagents. The nitrocellulose membrane test strip is commonly used, that is, the testing area includes a nitrocellulose membrane on which specific binding molecule is fixed to display the detecting result; and other test strips such as cellulose acetate membrane or nylon membrane test strips can also be used. Of course, in the downstream of the testing area, there may also be a detecting result control area; generally, test strips appear on the control area and the testing area in the form of a horizontal line, that is a detection line or a control line, and such test strips are conventional. Of course, they can also be other types of test strips using capillary action for detection. In addition, there are often dry chemical reagent components on the test strip, for example immobilized antibody or other reagents. When the test strip meets liquid, the liquid flows along the test strip with the capillary action, and the dry reagent components are dissolved in the liquid, then the liquid flows to the next area, the dry reagents are treated and reacted for necessary detection. The liquid flow mainly relies on the capillary action. Here, all of them can be applied to the test device of the present invention or can be disposed in contact with the liquid samples in the detection chamber or used to detect the presence or absence of analyte in the liquid samples that enter the detection chamber, or the quantity thereof.

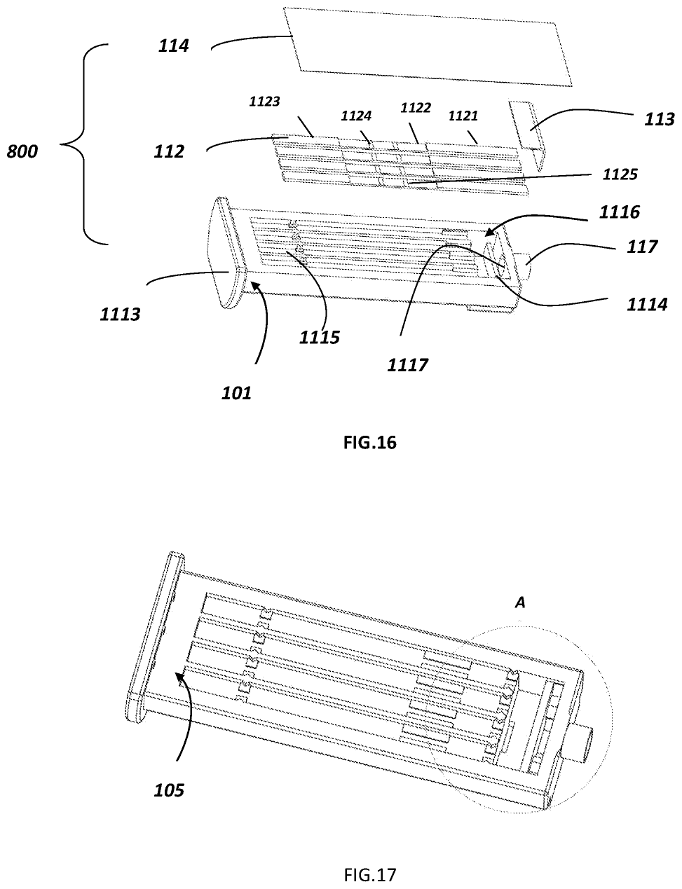

In addition to the foregoing test strip or lateral flow test strip which is used to contact with the liquid to test whether the liquid samples contain analytes. In some preferred embodiments, the testing element is disposed on some carriers 101, as shown in FIG. 16, for example, on some carriers having a plurality of grooves 1115; the testing element is located in the groove 1115. In some embodiments, the carrier 101 includes a groove area; the groove area includes a plurality of grooves 1115; a testing element or a testing strip is put in each groove. There is a recessed area 1116 near the groove area. The recessed area includes a baffle 1114. The baffle is located in front of the opening 1117 of the liquid inlet channel 117 on the carrier. The recessed area is generally in a rectangular shape. Alternatively, the recessed area is located between the liquid inlet 1117 and the grooved area. When the testing element is placed on the groove 1115, the bottom end 1121 of the sample application area does not extend above the grooved area, and has the same length with the groove 1115. In some embodiments, a flow guiding element 113 (as shown in FIG. 16) is further disposed on the carrier 101, and the flow guiding element 113 is located between the baffle 1114 and the opening 1117, and close to the bottom end of the sample application area of the testing element; in this way, when liquid flows from an inlet 1117, the liquid may possibly produce an impact force on the wall near the test strip in the groove 1115 due to fast flow rate, such that the liquid may contact with the test strip in advance, thereby causing detection in advance of the test strips. To avoid such a problem, it is desirable that all the test trips (when a plurality of test strips are included) contact with liquid for simultaneous reaction, thus obtaining test results simultaneously. The flow guiding element 113 is disposed in the recessed area, such that one end of the flow guiding element 113 is disposed in front end of the inlet 1117; and another end thereof covers on the sample application area 1121 of the test stripe. In this way, liquid flowing from the inlet 1117 will firstly contact with the flow guiding element 113, thus exerting barrier functions and preventing the liquid from contacting the test strip. Furthermore, the flow guiding element 113 makes the liquid exerting a buffer action, such that the whole recessed area 1116 is full of or filled with liquid; in this way, when liquid level rises until the groove is about to be filled with liquid, liquid is almost in contact with the test strip, which ensures that the starting time of the detection or assay of each test strip is almost consistent.

In some embodiments, as shown in FIG. 17-19, the recessed area 1116 of the carrier 105 is further provided with a through hole 1017; one end of the through hole is connected to the recessed area 1116, another end thereof is disposed on the back of the carrier and communicated with the outside world. The through hole 1017 has two functions, when liquid flows to the groove from the channel 111 of the collector via the inlet 1117, the through hole may discharge excessive gas therein, such that liquid flows into the groove 1115 smoothly. Excessive gas in the groove may be discharged, this is because the carrier, testing element and groove are located in a relatively sealed environment; when liquid flows to the sealed environment, and excessive gas in the groove is not discharged, the grooved area is hardly filled with liquid. Another function of the through hole is to discharge excessive liquid, after the recessed area is filled with liquid, if there is excessive liquid to flow into the groove or onto the test stripe, too much liquid may cause a torrent effect (flooding) if flow onto the test stripe, resulting in an incorrect result, and even invalid detection result. The through hole 1017 may discharge excessive liquid to the back of the carrier (FIG. 19). In some embodiments, some absorbent paper (not shown in FIG. 19), for example, filter paper, may be disposed on another end, for example, an outlet, of the through hole 1017, used to absorb excessive liquid, such that liquid will not flow out of the carrier, causing environmental pollution and the like (FIG. 19). In this embodiment, the sample application area 1121 of the testing element may be overlapped on the baffle 1114. That is, the length of the testing element is the length of the groove on the carrier, equal to the width of the recessed area. In this way, when liquid flows into the baffle 1114 and the area in front of the liquid inlet 1117, liquid may directly flow onto the testing element; if there is excessive liquid, the excessive liquid flows into the recessed area via the baffle and flows out via the through hole 1017. In this embodiment, the flow guiding element 113 may be absent to reduce the production process. In this way, the space where the testing element is located is the space of the carrier which is actually provided with a through hole; the space where the testing element is located is communicated with the atmosphere, and the pressure is the same or equal to the ambient pressure.

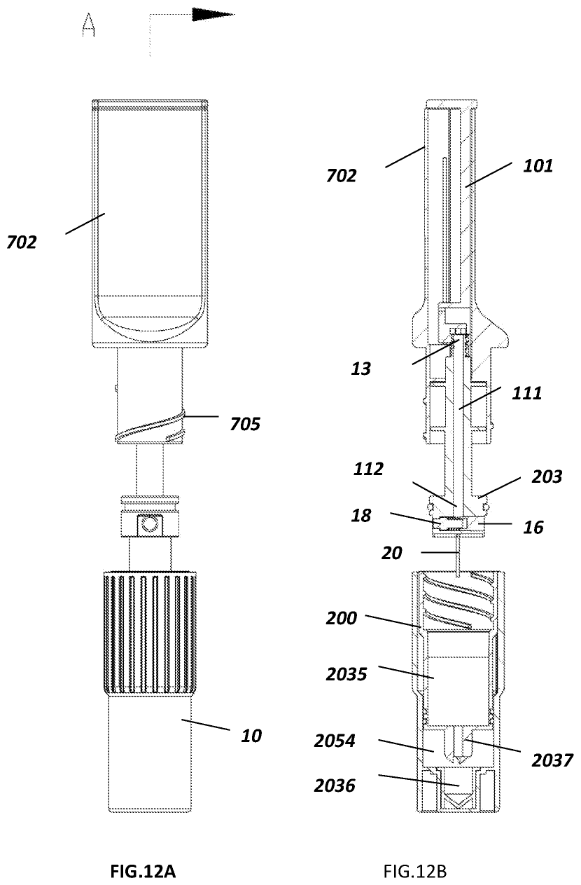

In some embodiments, after the testing element is disposed in the groove 1115 of the carrier, the carrier is covered with a transparent film 114, to seal the groove area of the carrier. In addition, it is easy to observe the final test results on the testing area from the transparent film. The film 114 may be a transparent plastic sheet, which is only transparent in the testing area. After covering the film 114, the testing element is located in the space formed between the carrier 101 and the film 114, and the film also covers on the recessed area 1116. In this way, the space is connected with one end of the 113 of the rodlike object channel via the liquid inlet channel 117 (as shown in FIGS. 11 and 12A-12B). In this way, the space where the testing element is located is connected with the space where the absorbing element is located via the channel 111 of the rodlike object 11. The space where the absorbing element is located is a sealed space formed after the absorbing element is inserted into the first receiving chamber.

In some embodiments, the liquid inlet 1117 on the carrier 101 is connected to a connecting conduit 117. One end of the connecting conduit is in fluidic communication with the liquid inlet, and another end thereof is in fluidic communication with or indirectly communicated with the space where the absorbing element 20 is located on the collector, while the absorbing element 20 is not directly communicated with the channel 111. In this way, when or after the absorbing element absorbs a liquid sample, the liquid sample will not flow onto the testing element via the channel 111 directly in advance to start test, which will be described in detail below directed to the design reason.

In some embodiments, if the carrier is directly kept in fluidic communication with the absorbing element (although such communication is controlled in the present invention), but it is still not very convenient and safe in operation, because it is not operated by a person trained in a professional laboratory. Users are not experienced and the sample collection or operation is not friendly, which may cause damage to the test strips, for example, different places where the hand is held. Fingers may compress the test strip or touch the test strip, which may have a negative impact on the test strip, affecting the final test results. In addition, the absorbing element needs to be inserted into the receiving chamber to squeeze the absorbing element, and also needs to push the piercing element to move, and release the liquid in the chamber to mix with the samples, etc. If it is completed by carrier itself, it is still unsafe and operators should be particularly careful. Therefore, in some embodiments, a chamber 702 for accommodating a carrier is provided, to allow the carrier 101 with a testing element to be disposed in the chamber for protection. In addition, the chamber 702 further has a connecting unit 1101 which contacts with the first receiving chamber via the connecting unit, so as to complete the movement of the first receiving chamber and the release of the treatment liquid in the second receiving chamber. The specific assembly way of the chamber 702 with the carrier 101 has been specifically described in the previous patent application of the applicant of the present application, for example, the detailed embodiments described in the PCT/IB2020/057053 may be cited as the embodiments of the present invention. In some embodiments, the connecting unit 1101 is further provided with screw threads 705; the screw threads are mutually meshed with the internal threads 62 in the first receiving chamber 60; when the test device provided with a collector is inserted into the first receiving chamber, as shown in FIG. 12B, the absorbing element 20 enters into the first receiving chamber 60 first, and followed by the end portion 203 of the collector, and then followed by the connecting unit 1101. The screw threads outside the connecting unit are in fit connection with the internal threads in the first receiving chamber, such that the connecting unit 1101 rotates into the first receiving chamber 60. In this way, the absorbing element is inserted into the first receiving chamber via the end portion 203 of the collector. To prevent the first receiving chamber 60 from rotating in the second receiving chamber 90, a bulge is disposed on the outer wall of the first receiving device, and a groove is disposed on the inner surface of the second receiving chamber. In this way, the first chamber may not rotate in the second chamber, but may move up and down. Moreover, when the test device makes a bulk movement, the first chamber may be pushed to move in the second chamber, thus achieving the compression of the gas in the sealed chamber of the second chamber and the release of the treatment liquid in the chamber containing the treatment liquid, and also increasing the pressure in the first chamber, for example, gas pressure or liquid pressure.

In some embodiments, the sample collector 103 may be connected to a conduit 117 connected to the liquid inlet 1117 of the carrier 101 through an end without an absorbing element to form a liquid communication. Of course, it is also possible to form fluidic communication with the carrier 101 or to form fluidic communication with the chamber where the testing element is located (the carrier 101 is covered by the transparent film 114 to form a chamber for accommodating the testing element), and a detachable connection, and then the chamber is in fluidic communication with the connecting conduit 11. To sum up, after the absorbing element collects the liquid samples, the fluid samples can be allowed to flow to testing element 112 via the channel 11 or the flow path of course in case that the controlling element is opened. Of course, the absorbing element is detachably connected with the carrier or chamber 102, to facilitate the separate sterilization of the absorbing element. Such a fluidic communication is controlled in the present invention.

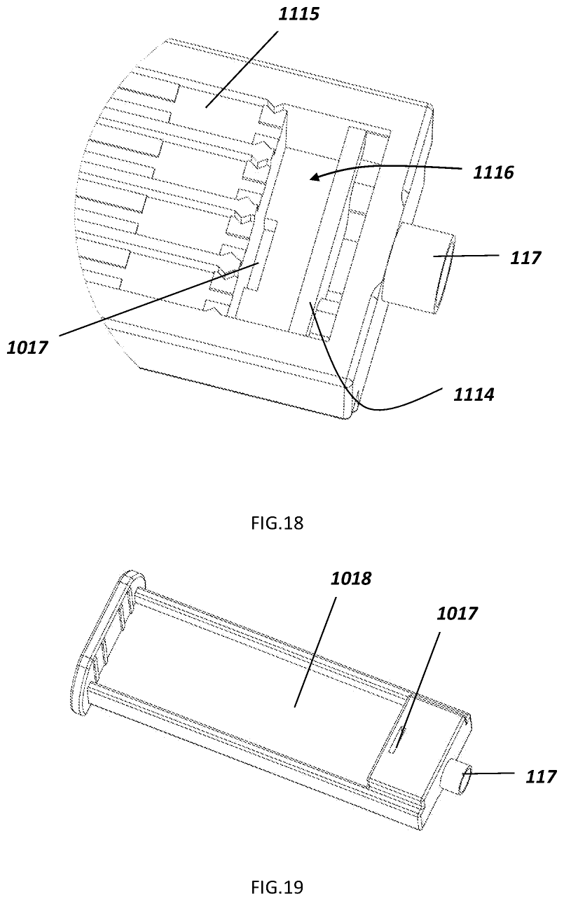

Generally, in the conventional test device, the absorbing element 20 is in direct fluidic communication with the testing element and uncontrollable; once the absorbing element collects a fluid sample, the fluid sample flows onto the testing element for assay in advance through a channel 11 in practical use. For example, in FIG. 18 described in PCT/IB2020/057053, the absorbing element 107 is directly communicated with the testing element via the channel 12 and is uncontrollable. Therefore, there are some shortcomings, for example, when the absorbing element is put in a mouth for sampling, the absorbing element generally becomes softer after absorbing a liquid sample, for example, saliva; during sampling, the absorbing element is easily squeezed (for example, occlusion of teeth), especially when the absorbing element is made of other materials; when the absorbing element is squeezed, the liquid sample absorbed on the absorbing element 107 may directly flow onto the testing element through a channel 11 for reaction in advance. Such kind of “reaction in advance” is not desired usually, but it is desirable that the reaction is limited under a controllable condition when necessary, or the fluid sample flows onto the testing element through a channel 301 after other operations under a controllable condition. Such a flow may be controlled intentionally, that is, the flow can be performed according to actual demands. Moreover, with reference to the test device described in PCT/IB2020/057053, during operation, as shown in FIG. 20, the absorbing element is inserted into the receiving chamber 1061; since the absorbing element 107 is kept communicated with the channel 12, and when the absorbing element 107 is squeezed, liquid can be released, but liquid on the absorbing element directly flows to the channel 12 and flows onto the testing element to start the test in advance. Such a result is not desired.

Therefore, in some embodiments, a controlling element is disposed between the absorbing element and the testing element; the “controlling element” may control the flow condition between the absorbing element and the testing element; the flow condition here generally means that the testing element is/is not in fluidic communication with the absorbing element. For example, during the collection of liquid samples, the controlling element makes the above two being not in fluidic communication, liquid on the absorbing element will not flow onto the testing element. No matter what condition the absorbing element is located in, for example, being squeezed, or being inserted into the chamber to be compressed; at this time, the controlling element will prevent liquid from the absorbing element from flowing onto the testing element in advance. When it is desired that liquid samples on the absorbing element flow onto the testing element, the controlling element makes the absorbing element and the testing element being in fluidic communication, such that liquid may flow between the both. How to control the controlling element, the specific structure design and operating method will be set forth in detail hereafter.

### Analyte

Examples that can use the analyte related to this invention include small-molecule substance, including drugs (such as drug abuse). “Drug of Abuse” (DOA) refers to using a drug (playing a role of paralyzing the nerves usually) not directed to a medical purpose. Abuse of these drugs will lead to physical and mental damage, produce dependency, addiction and/or death. Examples of DOA include cocaine, amphetamine AMP (for example, Black Beauty, white amphetamine table, dextroamphetamine, dextroamphetamine tablet, and Beans); methylamphetamine MET (crank, methamphetamine, crystal, speed); barbiturate BAR (e.g., Valium, Roche Pharmaceuticals, Nutley, and New Jersey); sedative (namely, sleep adjuvants); lysergic acid diethylamide (LSD); depressor (downers, goofballs, barbs, blue devils, yellow jackets, methaqualone), tricyclic antidepressants (TCA, namely, imipramine, Amitryptyline and Doxepin); methylene dioxymetham-phetamine (MDMA); phencyclidine (PCP); tetrahydrocannabinol (THC, pot, dope, hash, weed, and the like). Opiates (namely, morphine MOP or, opium, cocaine COC; heroin, oxycodone hydrochloride); antianxieties and sedative hypnotics, antianxieties are drugs for alleviating anxiety, tension, fear, stabilizing emotion and having hypnosis and sedation, including benzodiazepines (BZO), non-typical BZs, fusion dinitrogen NB23Cs, benzoazepines, ligands of a BZ receptor, open-loop BZs, diphenylmethane derivatives, piperazine carboxylates, piperidine carboxylates, quinazoline ketones, thiazine and thiazole derivatives, other heterocyclic, imidazole sedatives/analgesics (e.g., oxycodone hydrochloride OXY, metadon MTD), propylene glycol derivatives, mephenesin carbamates, aliphatic compounds, anthracene derivatives, and the like. The test device of the present invention may be also used for detecting drugs which belong to medical use but is easy to be taken excessively, such as tricyclic antidepressants (Imipramine or analogues), acetaminophen and the like. These medicines will be resolved into micromolecular substances after being absorbed by human body, and these micromolecular substances will exist in blood, urine, saliva, sweat and other body fluids or in some of the body fluids.

For example, the analyte detected by the present invention includes but not limited to creatinine, bilirubin, nitrite, proteins (nonspecific), hormones (for example, human chorionic gonadotropin, progesterone, follicle-stimulating hormone, etc.), blood, leucocyte, sugar, heavy metals or toxins, bacterial substances (such as, proteins or carbohydrates against specific bacteria, for example, Escherichia coli. 0157: H7, Staphylococcus, Salmonella, Fusiformis genus, Campylobacter genus, L. monocytogenes, Vibrio, or Bacillus cereus) and substances associated with physiological features in a urine sample, such as, pH and specific gravity. The chemical analysis of any other clinical urine may be conducted by means of a lateral cross-flow detection way and in combination with the device of the present invention.

### Flow of Liquid

Generally, the flow of liquid means that liquid flows from one place to another place. Under normal circumstances, liquid flows from a high place to a low place due to gravity in the natural world. The flow of liquid herein relies on an external force, i.e., gravity, which can be called a flow due to gravity. In addition to gravity, liquid can also flow from a low place to a high place by overcoming the gravity. For example, liquid flows from a low place to a high place due to extraction, oppression or pressure, or by overcoming its gravity due to pressure.

### Collector

The collector 103 here is provided with the absorbing element 20, and the absorbing element may absorb a fluid sample. In some embodiments, the collector includes an absorbing element 20 and a tube 11 containing a channel; one end of the channel 111 is an inlet 112, and another end is an outlet 113; the outlet 113 is connected with the conduit 117 of the carrier 101. In this way, fluid from the inlet 112 of the channel 111 may flow into the carrier 101 via the outlet 113. In the carrier, the testing element is accommodated in the chamber, and in this way, when the fluid is gas, the gas is discharged to the atmospheric environment via the outlet 1017 on the chamber 102 communicated with the atmosphere. When the fluid is liquid, the liquid flows into the chamber 102 and contacts with the testing element for assay or detection. The excessive liquid is discharged as well via the outlet 1017 communicated with the atmosphere, and the discharged liquid is absorbed by the absorbing element located near the outlet, for example, filter paper and the like (not shown) (FIG. 19).

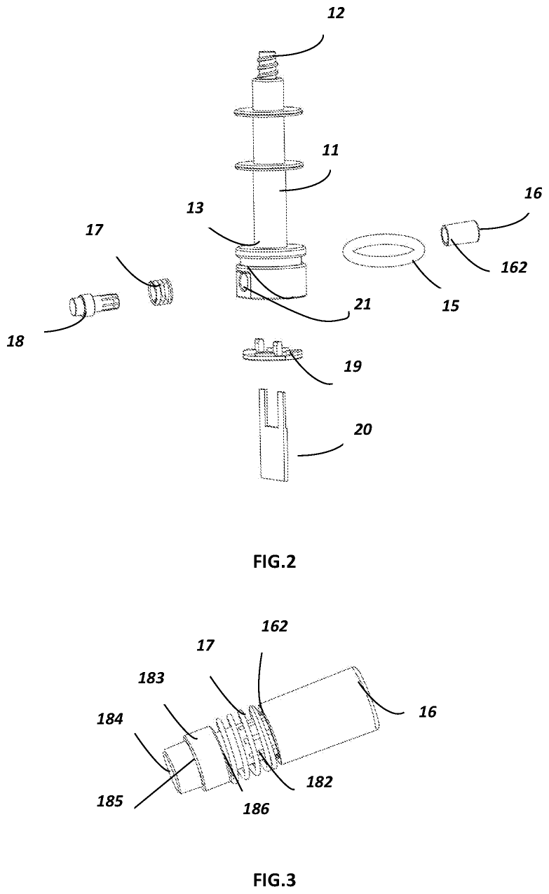

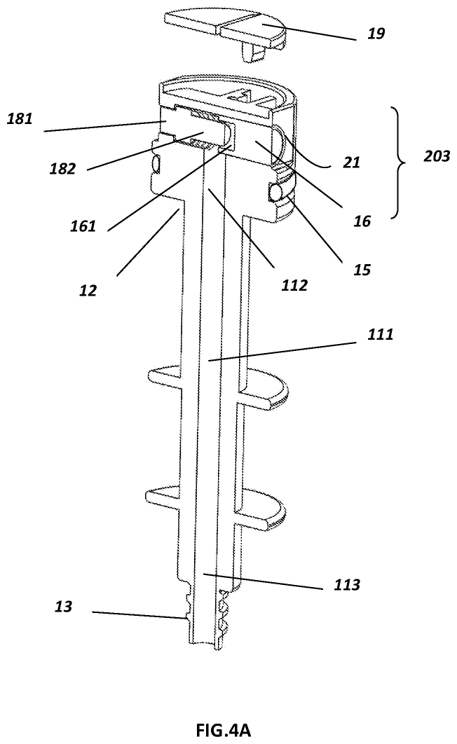

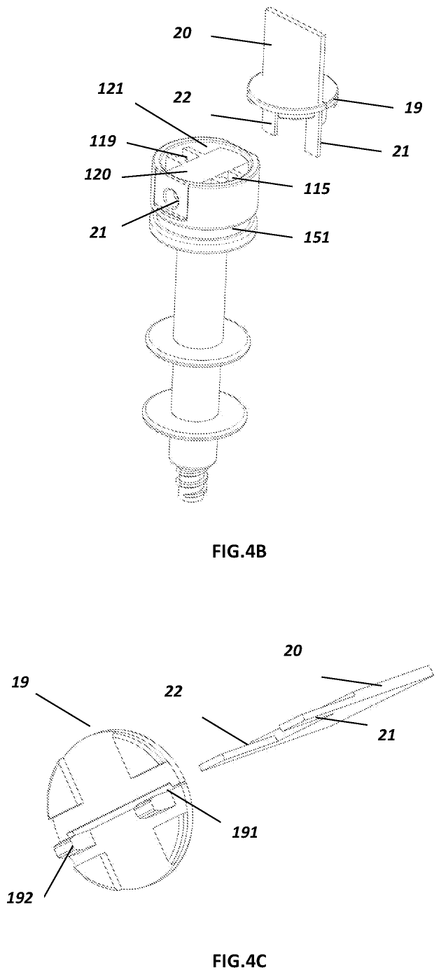

In some embodiments, as shown in FIGS. 2-4, the absorbing element on the collector is not directly communicated with the channel 111 in the tube 11, but a controlling element is disposed near the tube inlet 112; the controlling element may control the on or off of the channel 111, such that liquid in the absorbing element indirectly flows into the channel 111 of the tube 11 via a controller. In an optional solution, even if the absorbing element absorbs a sample, the sample may not flow onto the testing element on the carrier 101 via the channel 111, and such a flow is controlled. For example, in FIG. 2, the absorbing element 20 is a flake-like filter paper, and the filter paper is fixed on an end portion 203 of the collector via a fixing element 19. In some embodiments, the absorbing element has an absorbent main body 23 which is a flake-like porous material. The main body has two fixed strips 21,22, and the fixed strips are respectively inserted into two holes 191,192 of the fixing element 19, and the assembled shape and structure are shown in FIGS. 4B and 4C. The fixing element is then covered on the end portion 203 such that the fixed strips 21,22 of the absorbing element are respectively inserted into the grooves 119,115 of the end portion. As can be seen from FIG. 4A, the position in the end portion inserted with the absorbing element is not connected with the piston chamber; liquid of the absorbing element will not flow into the piston chamber 21 directly. In this way, the liquid will not flow into the channel 111. The fixing element may be fixedly connected with the end portion in an ultrasonic welding way. The end portion is further provided with a face plate 120, and a piston chamber 21 is disposed below the face plate. As can be seen from FIG. 4A, the filter paper is not communicated with the channel 111 in the tube 11, and cannot be communicated. In this way, when a filter paper is used to collect a saliva sample and because the absorbing element absorbs the saliva sample, the collected person may conscientiously or unconsciously touch the absorbing element with teeth or tongue, such that the absorbing element may be squeezed, and liquid will not directly flow into the channel 111. A controlling element is disposed in the piston chamber 21 on one end of the channel, and when the controlling element is in the initial state, the channel 111 is closed, and liquid will not flow into the channel 111 spontaneously. When the absorbing element is inserted into the chamber in the following specific operation, and the absorbing element is squeezed, the released liquid will not directly reversely flow to the channel 111. In this way, liquid is avoided to flow into the channel 111 in advance and then flow onto the testing element in the carrier 101 to start the test.

In conventional ways, the squeezed absorbing element will release liquid, and the liquid may flow onto the testing element via the channel 111 directly to start the test in advance, which will cause a wrong test result. Moreover, a sample treatment liquid is desired to treat a sample, it is desired to compress the absorbing element. The process of compression may also make liquid flowing into the channel 111 of the tube 11 to start the test in advance. Such a way has been specifically described in PCT/IB2020/057053: for example, in FIG. 18, the absorbing element 107 is connected on one end of the tube channel 12, and the absorbing element is directly communicated with the channel 12, which may cause the start of test in advance. Further, when such a device is inserted into the first receiving chamber 1061, the purpose of the insertion is to squeeze the absorbing element 107 to release liquid. In the process, liquid may be brought into the channel 12 to flow onto the testing element, thus starting the test in advance.

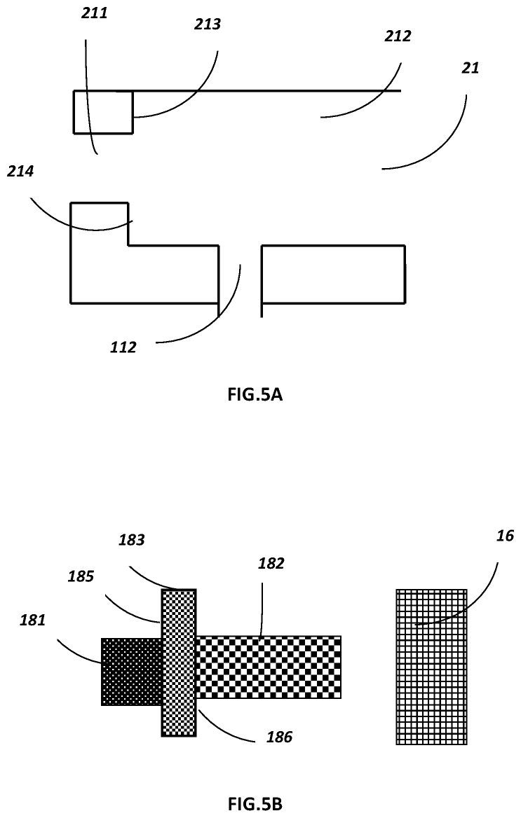

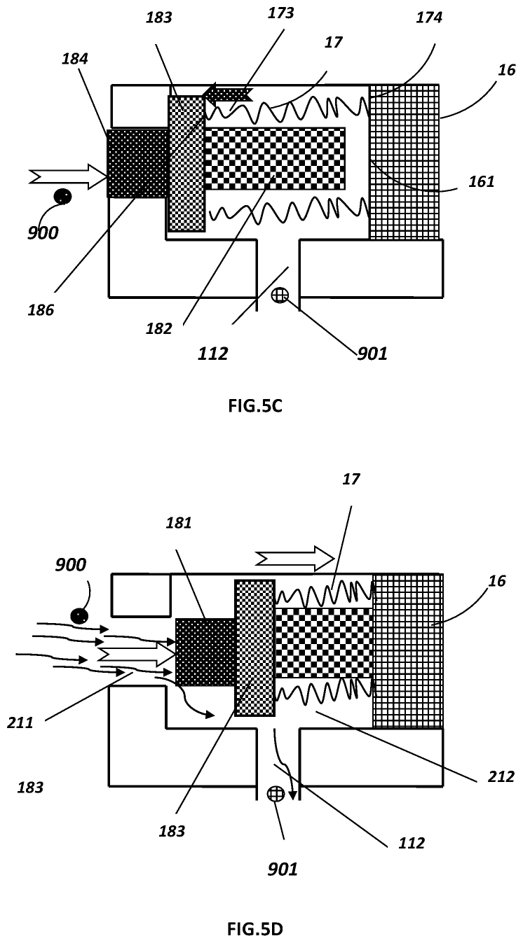

To improve these shortcomings, in this present invention, one end of the channel 111 is provided with a controlling element, and the controlling element will not make the liquid released from the absorbing element due to squeezing (in the process of sample collection, or in the process of being inserted into the first receiving chamber to squeeze the absorbing element) flowing into the channel 111 directly. One end 112 of the channel 111 is connected with the controlling element, and another end 113 is connected with the chamber for accommodating the testing element. In this way, liquid only enters into the channel 111 via the controlling element, and when the controlling element is in the initial position, the channel 111 is closed. In some embodiments, the controlling element disposed on one end 112 of the channel includes a piston 18; the piston is disposed in a piston chamber 21. When there is no piston 18, the piston chamber 21 is communicated with the channel 112 (FIGS. 4B, 4B and 5A), and when the piston chamber 21 is provided with the piston (FIGS. 4D and 5C), the piston blocks one end of the piston chamber 21, thus forming a blocking state on one end of the channel 112. In a detailed embodiment, the piston chamber passes through the end portion 203, and a piston base 16 is inserted at one end of the piston chamber; the base has a chamber 161 and a portion of the piston may enter into the chamber 161, and the chamber has a preset height or depth. Such a configuration limits the depth of the piston into the chamber. Specifically, the piston has a piston body 18, and the piston body has a piston bolt 182, a limiting part 183 and a piston column 181; the piston bolt 182 may enter into the chamber 161 of the base, and the depth of the chamber of the base limits the depth of the piston bolt. The limiting part 183 contacts with the interface 213 of the piston chamber 21 and limits the position thereof. The piston column 181 is located in the first chamber 211 of the piston chamber, and the bolt is located in the second chamber 212 of the piston chamber 21; the piston chamber 21 or piston channel has two chambers; the first chamber 211 is used for receiving the piston column 181, and the second chamber 212 is used for receiving the piston bolt 182 and the piston base 16. The first chamber 211 (the cross section has diameter of H) and the second chamber 212 (the cross section has diameter of h, where H is less than h) in the piston chamber 21 form an interface 213; the cross section of the first piston chamber 211 is less than that of the second chamber 212. In this way, the cross section of the piston column 181 is substantially similar to that of the first chamber 211, and the cross section of the second chamber 212 is substantially similar to that of the piston base 16, and the diameter of the piston bolt 182 is less than the diameter of the second chamber. In this way, the piston limiting part 183 is buckled on the interface 213 of the piston hole, the bolt may move from left to right freely in the second chamber 212 of the piston hole; when the piston is located in the initial position, the piston column 181 of the piston 18 seals the first chamber 211 of the piston chamber 21. Therefore, the piston chamber is blocked, and one end 112 of the channel 111 is also sealed; when the piston 18 moves against the piston base 16, the piston column 181 is retracted in the piston chamber 211 and the face 185 of the piston limiting part 183 is far away from the limiting face 213 in the piston chamber; the channel 111 forms communication via the piston chamber 21 and the outer space where the end portion 203 of the collector 102 is located. In this way, if the absorbing element is located in the outer space of the collector, the outer space is directly communicated with the channel 111 via the piston chamber.

The piston herein is cylindrical, and the piston hole or piston channel 21 is also circular, of course may be any other shapes, such as square, rhombus, and oval, and the like. In this embodiment, one end 112 of the channel 111 is mutually communicated with the piston chamber 212, and the controlling element is disposed in the piston chamber or piston hole. What is described above merely introduces a setting mode of the piston in the piston chamber, and of course there are other ways. For example, instead of piston, an elastic film is covered at one end of the piston chamber. The elastic film has a small hole, and the small hole has self-sealing properties; the small hole is self-scaled in normal conditions; when pressure in the space where the absorbing element is located rises, the rising pressure enables the self-sealed small hole to be opened, thus discharging the excessive gas into the piston chamber. The self-sealed small hole may be made of an elastoplastic and an elastic emulsion.

In one embodiment, the controlling element further includes an elastic element, for example, a spring 17; the spring is wound on the piston bolt or disposed between the piston limiting part 183 and the base 16, as shown in FIGS. 3-4. One end of the spring 17 contacts with the bolt of the limiting part 183 to form the cross section 186, and another end contacts the edge 162 or base of the chamber of the piston base. During assembly, the piston may be firstly inserted into the piston hole from the right of the piston chamber 21, such that the piston column is located in the first chamber 211 of the piston chamber, and then successively inserted into the spring; the piston bolt passes through the spring 17, and then the base 16 is inserted into the piston chamber 21 such that the whole piston 18 and base are completely inserted into the chamber 21 (4A). At this time, the spring 17 is compressed to have an elastic force to recover free state reversely. The clastic force forces the face 185 of the piston liming part 182 to lean against the interface 213 closely, while the piston bolt 183 is not in contact with the bottom of the chamber 161 of the base 16 to have a certain distance. At this time, the piston substantially seals the piston hole or the first chamber 211 of the piston channel (relying on the piston column 181 or piston liming part 183). Even though one end 112 of the channel 111 of the tube 11 is communicated with the piston chamber 212, the first piston chamber is sealed by the piston. Therefore, no matter how the absorbing element is squeezed, liquid will not enter into the tube 111 directly. In this way, the liquid or gas in the space where the absorbing element is located will not be in direct communication with the space where the testing element is located, ensuring that liquid on the absorbing element will not flow onto the testing element. As shown in FIG. 11, the absorbing element is located at one end of the test device 100, and the testing element is located at another end of the test device. Generally, the space where the testing element is located is fixed, and the space where the absorbing element is located is not in the same space with the testing element, but the two spaces are communicated via a channel. The channel is provided with a controlling element; the controlling element will be closed or opened due to the pressure difference between the two spaces. In this way, the channel is closed or opened to form two different states (two spaces are communicated or not communicated).

In some embodiments, if an external force is applied on the end face 184 of the piston column 181 of the piston 18, and the external force can overcome or be higher than the rebound force of the spring 17, the piston may be pushed to move within the piston hole 212 such that the piston bolt 182 moves towards the chamber 161 of the base 16. Therefore, the piston chamber 21 is opened such that the outside world may be communicated with one end 112 of the channel 111 via the piston chamber 21. In this way, the outside gas or liquid near the absorbing element may flow into the channel 111 via the piston chamber 21, thus flowing onto the testing element. As shown in FIG. 5C, one end 173 of the spring 17 touches the face 183 of the piston limiting part 183, and another end 174 thereof contacts the face 161 of the base. The spring is compressed in the initial position such that the rebound force enables the face 185 of the piston limiting part 183 to contact the faces 213,214 of the piston chamber. It is understood that the scaling of the piston chamber may be as follows: the piston column 182 seals the piston chamber 211, and also the piston limiting part 183 seals the piston chamber 211, of course, the two forms of sealing are available. In some embodiments, the outside herein includes the space where the absorbing element is located, but excludes the space where the testing element is located. That is, the space 901 where in the testing element is located (second space) is different from the space 900 where the absorbing element is located (first space), and the two spaces are partitioned by the controlling element. The external force may be a mechanical force, for example, a push rod pushes the motion of the piston 18, and the push rod gives the piston a pushing force towards the piston hole such that the piston is retracted into the piston hole 21, thus opening the piston hole to be an unsealed state. In this way, the outside gas or liquid (gas or liquid in the first sealed space) will flow into the piston chamber to be communicated with the channel 111, thus flowing into the channel 111. Once the pushing force disappears, the piston will restore to the initial sealing position or closed position due to the rebound force of the spring, thus cutting off the fluidic communication state between the channel 111 and the outside (FIG. 5E). In a preferred embodiment, the external force is pressure, for example, gas pressure or liquid pressure; the pressure forces the piston to move towards the direction close to the base 16 within the piston hole; and the pressure is higher than the rebound force of the spring. It may be understood in this way that the channel 111 has two ends; one end 112 is connected with the piston chamber 21, and the piston chamber is provided with a piston 18, the face of the piston column 181 provided with the piston 18 is located in the same space 900 (a first space or first sealed space) with the absorbing element 20. One end 184 of the piston is connected with the space where the absorbing element is located, and another end 113 of the channel is connected with the space where the testing element is located (for example, the chamber in the carrier, or the space of the atmosphere, a second space); two ends of the channel and the testing element are located in the same space with equal pressure. In the initial state, the pressure of the two spaces (900 and 901) is the same; that is, the pressure in the piston chamber 212 and one end 112 of the channel is equal to the pressure in the space 900 where the piston end face 184 is located, where the channel 111 is located in the same space with the testing element. At this time, the piston sealing column 181 is located in the first piston chamber 211 of the piston by relying on the rebound force of the spring 17 to seal the piston chamber 211, thus sealing one end 112 of the channel 111, which may be not in gas or liquid circulation with the space where the absorbing element is located. When pressure in the space 900 where the absorbing element is located (first space) rises to be higher than the pressure in the space 901 where the testing element is located, there is a pressure difference between the two spaces. The pressure difference forces the gas or liquid in the space 900 where the absorbing element is located to flow towards a low-pressure space 901. At this time, the pressure pushes the piston 18 to move towards the direction close to the base 16, and the piston opens one end 211 of the piston hole 21 such that the closed channel 111 forms a communication with the space where the absorbing element is located. In this way, the gas or liquid in the space where the absorbing element is located will flow into the channel 111 via the piston chamber 211 (FIG. 5D), thus flowing into the space where the testing element is located. In some embodiments, the space containing the testing element is communicated with the outside atmosphere; when the pressure rises to be higher than the barometric pressure, the rebound force of the spring will be overcome to open the piston. After the gas or liquid in the space where the absorbing element is located is discharged into the space where the testing element is located, the pressure difference will reduce until the same, or less than the rebound force of the spring. At this time, the spring 17 enables the piston column 18 to restore to the initial position relying on the rebound force, thus sealing the first chamber 211 of the piston chamber 21 and achieving the partition between the space where the absorbing element is located and the space where the testing element is located (FIG. 5E). The movement of the piston herein refers to automatic movement. The automatic movement refers that the change of the external environment makes the position of the piston changed automatically.

The increase of pressure herein may include the increase of the pressure in the space containing the absorbing element; the increase of pressure may be achieved by the followings: the gas within the space is compressed to reduce the gas volume to increase the pressure, or liquid in the space is applied a pressure to increase the pressure, which is equivalent to the increase of the liquid pressure. It may be understood that the space containing the absorbing element is a sealed space such that the gas in the sealed space may be compressed.

In some embodiments, the increase of pressure in the sealed space where the absorbing element is located is achieved as follows: gas or liquid in the sealed space is compressed by the end portion of the collector to increase the internal pressure.

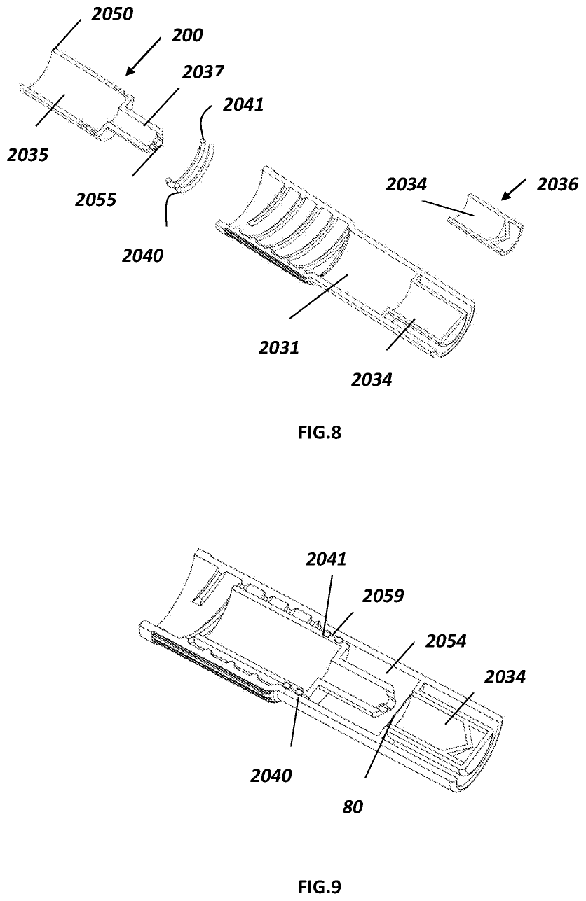

In some embodiments, the space containing the absorbing element is a sealed chamber, and when the absorbing element is inserted into the chamber, the end portion 203 of the collector 103, namely, the end portion of the piston hole 21 drives the absorbing element 20 to be inserted into the chamber, and the chamber is sealed by the end portion 203. Specifically, the chamber 200 has an opening 2050, and the absorbing element is inserted into the chamber via the opening; and the opening 2050 of the chamber is sealed by the end portion 203 of the collector such that a sealed space containing the absorbing element is formed in the chamber. As shown in FIG. 8, one end of the chamber 200 has an opening 2050, and another end is shown to have an opening 2055, but of course, the opening 2055 may be closed. In such an embodiment, the end portion of the collector contains a sealing ring, for example, a silica gel scaling ring 15; the sealing ring is elastic. When the end portion 203 is inserted into the chamber via the opening 2050, the elastic sealing ring is matched with the inner wall of the chamber such that a sealed space 2035 containing the absorbing element 20 is formed in the chamber. If the chamber includes another chamber 2037, the two chambers form a sealed space (a first sealed space), or a sealed chamber. At this time, the end portion 184 of the piston column of the piston element 18 is connected with the sealed chamber; that is, the chamber 211 of the piston channel 21 provided with the piston 18 is connected with the sealed space, for example, located in the sealed space; one end 112 of the channel 111 connected with the piston is connected with the sealed space via the piston 18, and another end 113 is connected with the space containing the testing element, for example, connected with a carrier.

If it is desired to compress the absorbing element or increase the pressure in the sealed chamber, the end portion 203 of the collector 103 is allowed to continuously move towards the sealed chamber 2035. In this way, when the chamber contains gas, the gas is compressed to increase the pressure in the sealed chamber; the rising pressure will be applied on the end portion 184 of the piston to force the piston 18 to move towards the direction close to the base 16, thus opening the first chamber 211 of the piston chamber 21. At this time, gas in the scaled chambers 2035,2037 will flow into the channel 111 of the tube 11 via the piston chambers 211,212 and will be discharged outside the sealed chamber containing the absorbing element 20, for example, flow into the space containing the testing element; the space where the testing element is located is generally the same as the atmospheric environment, thus being discharged into the atmospheric environment. If the end portion 203 will not continue to move at this time, gas in the sealed chamber is discharged to the outside. When the pressure in the sealed space is kept substantially the same as the outside pressure, for example, equivalent to the pressure in the space containing the testing element, the pressure on the end portion 184 of the piston disappears, or is less than the rebound force of the spring. At this time, the rebound force of the spring pushes the piston to move towards the direction away from the base 16, thus sealing the piston channel again and cutting off the fluidic communication between the tube channel 111 and the sealed space containing the absorbing element.

When or after the gas in the sealed chamber is discharged, the end portion 203 of the collector continues to move downwards. At this time, the absorbing element is squeezed to release liquid samples, and if liquid is still remained, for example, if the liquid released by squeezing the absorbing element is remained in the sealed chamber, the end portion 203 continues to apply a pressure on the sealed chamber, the volume of the scaled space 2035 will be continuously reduced, and the pressure is also applied on the liquid. At this time, the pressure of the liquid will rise to exert a pressure on the piston end portion 184 once again; the pressure forces the piston 18 to move towards the direction close to the piston base 16 once again. The motion of the piston opens the piston chamber 21 again, and the piston chamber 21 is communicated with the channel 111 of the tube 11. In this way, liquid flows into the piston chamber 21 and thus flows into the channel 111 of the tube. In this way, the liquid may flow into the carrier 101 of the testing element to contact with the testing element, thus achieving assay or detection on the analyte in the liquid. Since liquid pressure is also a gradually decreased process, liquid continuously flows out of the sealed space, and the liquid pressure will decrease gradually. During the process of decrease, the existing liquid pressure will continue to promote the liquid to flow into the channel 111 such that the liquid flows into the space containing the testing element, for example, a liquid sample flows into the opening 1117 of the carrier and thus flows onto the carrier. In this space, the testing element contacts the liquid to complete the test or detection of the analyte in the liquid. Once the liquid pressure in the sealed chamber containing the absorbing element 20 is equal to the outside pressure, the rebound force of the spring makes the piston 18 away from the piston base 16 to seal the piston chamber 21 once again, which blocks the liquid communication between the sealed chamber containing the absorbing element and the space where the testing element is located. In some embodiments, the distance of the piston 18 moving to the piston base 16 is constant. The constant distance is determined by relying on the insertion depth of the piston bolt 182 into the piston base. That is, after a pressure is applied on the piston end portion 184, the distance of the piston moving to the bottom of the piston is constant. In this way, liquid pressure is basically kept consistent, for example, the rising pressure is constant, the volume of the liquid flowing into the piston chamber 21 and into the channel 111 of the tube 11 is also constant. In this way, the volume of the liquid flowing into the space where the testing element is located may be limited to form quantitative detection. The change of liquid volume will also cause different test results; if the liquid volume detected by each device is kept basic constant, there is no larger deviation among the test results, thus keeping constancy.

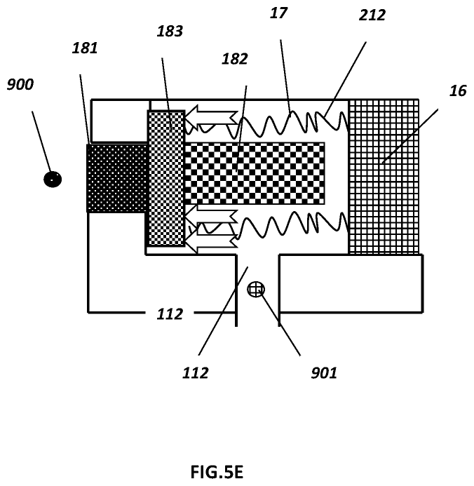

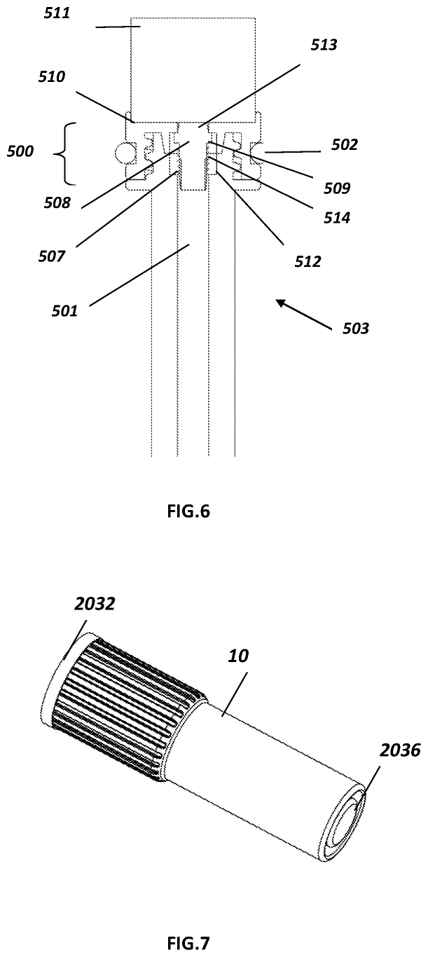

In some other embodiments, for example, as shown in FIG. 6, a collector 503 is provided. The collector includes an end portion 500, and an absorbing element 511, for example, a cylindrical water absorbing sponge or polypropylene, etc., is bound on the platform 510 of the end portion. The absorbing element is cylindrical; a piston body 508 is disposed at the end portion of the rodlike channel 501, and the type of the piston body is similar to the shape of the piston as shown in the above FIGS. 2-4; the piston body also has a spring 507; the spring is mounted on a piston bolt; one end touches a piston limiting part 509, and another end touches one face 512 at the tail end of the channel 501. In this way, the clastic force makes the piston column 513 sealing the opening of the piston chamber. The piston chamber 514 is a portion of channel at the tail end of the channel, thus sealing the piston chamber at one end of the channel 501. At this time, the piston is in the initial state; when the end portion of the collector is inserted into a chamber, the collector at the end portion seals the opening of the chamber (e.g., an end portion 500) such that a sealed space is formed in the chamber. The sealed space contains the absorbing element. If the end portion 500 continues to move towards the chamber, gas in the sealed space is compressed to increase the pressure in the sealed space. The rising pressure makes the piston contracted inward after through the absorbing element, such that the excessive gas flows into the channel 501 from the piston chamber 514. The chamber is communicated with the space where the testing element is located and thus, is discharged to the atmospheric environment. When the end portion 501 continues to move inwards, the absorbing element is compressed to release the liquid sample; the continuous movement will continuously increase the pressure of the sealed space. Liquid will flow through the absorbing element to make the piston contracted inwards, thus opening the piston channel; then the liquid flows into the channel 501 and into the space where the testing element is located, thus contacting the testing element to achieve the test. Of course, if the absorbing element is not completely covered on the plane of the end portion 510, and not covered on the area of the piston column 510, the piston column is directly connected with the space where the absorbing element is located to decrease the resistance on the absorbing element 511, making gas or liquid exchange more smooth.

In some embodiments, the space where the absorbing element is located is located in another sealed space; the space where the absorbing element is located is in fluidic communication with the sealed space. A pressure is applied on the gas or liquid in another sealed space, thus increasing the pressure, which forces the pressure in the space where the absorbing element is located to increase. In the embodiment, the rising increase in another sealed space makes the space where the absorbing element is located moving in the sealed chamber, such that the gas in the sealed space is compressed to increase the pressure. As understood actually herein, the space containing the absorbing element is unsealed by itself, but the space is located in a sealed space; the space containing the collector has an opening in fluidic communication with the sealed space, and the absorbing element is also in a large sealed space in practice (including a space containing the absorbing element). The pressure in the large scaled space will increase as long as the gas or liquid in the large sealed space is compressed. It will be described in detail with reference to detailed examples.

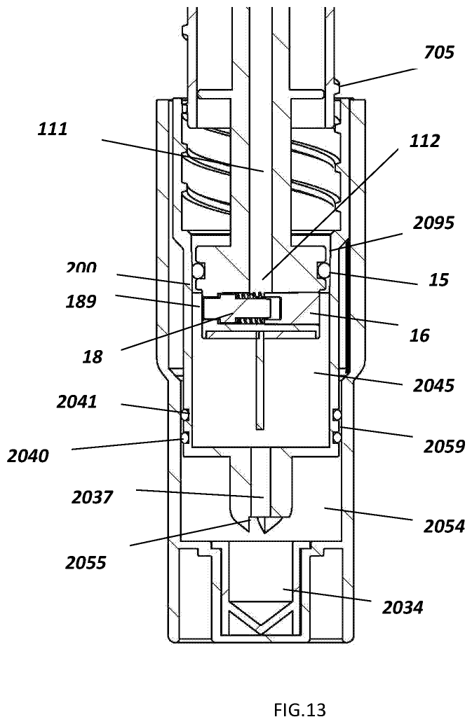

As shown in FIGS. 8-9, a first receiving chamber 200 is provided; the chamber has an opening 2050 on one end and an opening 2055 on another end; when the first receiving chamber is inserted into the second receiving chamber 10, the second receiving chamber is closed on one end and has an opening 2032 (FIG. 7) on another end. The first receiving chamber is inserted into the second receiving chamber to form a sealed space 2054 in the second receiving chamber. When the absorbing element is inserted into the first receiving chamber 2035, the opening of the first receiving chamber is sealed by the end portion 203 of the collector to form a sealed space in the second receiving chamber. The scaled space includes a chamber 2035, and a first receiving chamber 2035, and a chamber space as shown by 2037 (FIGS. 9 and 13). At this time, the space 2045 in the first receiving chamber, the space shown in 2037 and the sealed space 2054 are in fluidic communication with each other (FIG. 13). At this time, if the first receiving chamber moves downwards in the second receiving chamber to compress the gas in the space 2054, for example, the excessive gas will flow into the chamber 2037 and the chamber shown in 2035 via the opening 2055 of the first receiving chamber to increase the pressure in the chamber. Therefore, as described above, the piston is forced to move to open the piston chamber, thus discharging gas to the channel 111. Similarly, if the first chamber continues to move in the second chamber, gas in the space 2054 is continuously compressed; if the end portion 203 of the collector also continues to move downwards in the first receiving chamber 2035, the pressure in the sealed space is increased. When there is liquid in the sealed space, a pressure is applied on the liquid to open the piston as described above; then the liquid flows into the channel 111 via the piston chamber, and flows into the carrier where the testing element is located via the channel 111, thus completing the detection of the analyte in the liquid.

It may be understood that based on the above description step by step only, either opening or closing of the piston is completed within a very short time; sometimes, the piston is in the opened position (from the initial closed state to the opened state), gas, gas-liquid mixture, or liquid in the sealed chamber or space is forced to flow into the channel 111 from the sealed space and thus, flowing into the space where the testing element is located. It will be further explained in combination with detailed operation steps. The piston will be in a closed state soon once gas or liquid flows out to make the pressure in the sealed chamber containing the absorbing element balanced with the pressure in the channel, which depends on the value of the pressure difference or the rate of the discharged gas or liquid.

### Test Device Containing the Testing Element

The test device refers to an apparatus for detecting the presence or absence of an analyte. The test device may include a test unit having a test function, for example, a testing element, or a carrier with a testing element. The test device may be provided with an absorbing element to collect the liquid samples, and the apparatus with the absorbing element to collect samples is also referred to as a collection device or a collector, so the collection device may also include a test device, or the collection device may be separated from the test device. At the time of detection, the collection device and the test device are combined to complete the detection. It is also possible that the collection device and the test device are an integrated structure, and once liquid samples are collected, the detection can be performed immediately to obtain the test result. Here, the connotation of the test device or testing element is interchangeable.

### Combination, Assembly or Matching of Collection Apparatus and Detection Apparatus

The detection apparatus and the collection apparatus of the present invention can form a detachable combination. Before liquid collection, the detection apparatus and the collection apparatus have combined together, and after the liquid sample collection, the absorbing element on the collection apparatus is compressed, and the liquid samples enter the testing element to complete the assay. Of course, the collection apparatus and the detection apparatus are detached initially, and when it is necessary to collect liquid samples, they can be combined together, and after the collection, the absorbing element is compressed, and the liquid samples enter the testing element to complete the testing. In some specific embodiments of the present invention, as shown in FIG. 5, the present invention provides a detection apparatus for detecting the presence or absence of analytes in the liquid samples, or a collection apparatus for collecting liquid samples, comprising a detecting unit and a collecting unit, of which, the detecting unit includes a testing element, and the collecting unit includes an absorbing element 20, of which, the detecting unit and the absorbing element are combined, connected or assembled in a detachable manner.

In fact, the “combination, connection or assembly” referred to herein have the same meaning, and are only different in their forms of expression. The “combination” is relative to “separation”. Combination and separation can be chosen freely under any conditions. In some embodiments, when the detecting unit is combined with the collecting unit, the detecting unit and the collecting unit are in a liquid flow state. In some other embodiments, before, when or after the detecting unit is separated from the collecting unit, the detecting unit and the collecting unit may be not in a liquid flow state.

In some embodiments, the absorbing element 20 is disposed on an end portion 203 of a connecting rod 11 to form a collecting unit or a collector or a collection apparatus. The absorbing element 20 can absorb a fluid sample, for example, any sample such as saliva, urine or blood, etc. One end 12 of the connecting rod 11 is connected to the end portion 203; the end portion is provided with a piston and an absorbing element 20, specifically, a connecting end portion; and the end portion includes a piston chamber 21 and is provided with the absorbing element 20 (FIG. 11), and another end 13 is connected to the connecting conduit 117 of the carrier 101 by a thread, a buckle or a lock, or a bolt and a jack. These methods can achieve connection or disassembly. Thus, when it is necessary to separately sterilize the absorbing element, separate sterilization can be performed by high temperature, X-ray, radiation sterilization, nuclear radiation, etc. After the sterilization, it is assembled with the carrier. Once being assembled, the channel 111 in the connecting rod 11 is in fluidic communication with the carrier 101.

### Chamber Containing the Testing Element

As shown in FIG. 16, the testing element 112 is located in a chamber; the chamber includes a carrier, and is provided with a plurality of grooves 1115 for accommodating the testing element 112; a film 114 is covered on the carrier to form a chamber for accommodating the testing element. The carrier further includes a recessed area 1116 and a baffle 1114, and a connecting tube 117 communicated with the chamber. One opening 1147 of the connecting tube is communicated with the chamber containing the testing element, another end is connected with one end 13 of the tube 11 of the collector. In this way, the carrier is connected with a collector, and one end of the channel 111 is connected with a controlling element, and another end is connected with a chamber containing the testing element. In this way, the absorbing element and the testing element are separated into two different spaces by the controlling element.

In some embodiments, the carrier includes a hole communicated with the outer atmosphere, and the hole may discharge excessive gas. In some embodiments, the carrier is provided with an absorbing element near the hole; when the excessive liquid flows out via the hole, the excessive liquid can be absorbed. As shown in FIGS. 17-19, the groove accommodating the testing element is also provided with a grooved area 1116 and also contains a baffle 1114. The baffle is located in front of an inlet 1117; when liquid flows from the inlet, the liquid directly flows to a sample application area of the testing element directly, and the excessive sample flows into a recessed area; the recessed area is provided with a hole 1017 communicated with the outside. In this way, a through hole is disposed on the back face of the carrier, and the back face has a recessed area 1018 where an absorbing material may be placed; the excessive liquid is absorbed by the absorbing material disposed in the area when flows into the recessed area 1018 via the through hole 1017. When gas flows into the recessed area 1116, the gas will be discharged to the atmospheric environment via the hole 1017. It may be understood in this way herein that the chamber containing the testing element is the same as the atmospheric environment in practice, and the pressure is also equal to the air pressure of the atmospheric environment. When pressure in the space containing the absorbing element rises, there is a pressure difference relative to the chamber of the testing element. The pressure difference is formed between the chamber of the testing element and the chamber of the absorbing element. When a controlling element is disposed in the channel between the two chambers, the pressure difference enables the controlling element to be opened automatically, such that the pressure difference decreases until the pressure between the two chambers is the same, the controlling element is closed automatically at this time. Therefore, the controlling element may be opened or closed automatically, namely, opened automatically from the initial closed state, and then closed automatically from the opened state, thus achieving the gas or liquid exchange between the sealed chamber where the absorbing element is located and the chamber containing the testing element. In one embodiment, directed to the so-called exchange, when the controlling element is opened, gas or liquid in the sealed chamber containing the absorbing element is transmitted to the space or chamber where the testing element is located.

### First Receiving Chamber and Second Receiving Chamber

In some preferred embodiments, the present invention further provides a receiving device for receiving a part of the detection apparatus, such that the sample on the absorbing element is subjected to a processing step or a process before the formal detection, for example, a first receiving chamber for receiving an absorbing element 20.

As shown in FIGS. 7-9, in one embodiment, the receiving device is also a first chamber structure 200, similar to a cover body or a tube structure. In some embodiments, the receiving device includes a first receiving chamber 200 with one opened end 2050 and another closed end 2055. The chamber element 200 is separated into a first chamber 2035 and a second chamber 2037; when the collector with the absorbing element is inserted into the chamber 2035, the absorbing element 20 is located in the chamber 2035. The end portion 203 of the collector seals the opening 2050 of the sealed chamber 200 to form a sealed space in the chamber 200; the end portion 184 of the piston 18 on the end portion of the collector is located in the sealed chamber 2035. As the end portion of the collector moves to the chamber, pressure in the sealed chamber rises, and the increased pressure promotes the piston 18 to change in position. Therefore, the sealed piston chamber is opened to discharge the excessive gas due to the increase of pressure. When the end portion 203 continues to move downwards, the absorbing element 20 is squeezed to release liquid; if the end portion 203 continues to move to apply a pressure on liquid; the applied pressure is passed to the end portion 184 of the piston 18 such that the piston moves to the base 16 and the first piston chamber 211 of the piston chamber 21 is opened, and the channel 111 is communicated with the sealed space via the piston chamber 212. At this time, liquid flows to the channel 111 from the sealed chamber via the piston chamber 21; the channel 111 is communicated with the testing element on the carrier 101, and liquid flows onto the carrier along with the channel 111 and contacts the testing element in the carrier.

In some embodiments, the second receiving chamber 10 includes a bottom portion 2033 and an opening 2032; the bottom portion is provided with a chamber 2036 used for accommodating the treatment liquid; the opening of the chamber is sealed by a film 80 readily pierced. The first receiving chamber 200 is located in the second receiving chamber and located in a movable position. For example, as shown in FIG. 9, the first receiving chamber 200 forms a sealed space 2054 in the second receiving chamber. The sealed space is the second scaled chamber 2054 formed by matching clastic sealing rings 2040,2041 outside the first receiving chamber with inner walls 2058,2059 of the second receiving chamber. At this time, the end portion 2055 of the first receiving chamber is not scaled but has a through hole communicated with the sealed chamber 2054. When the end portion of the collector 103 is inserted into the first receiving chamber (FIG. 13); the end portion seals the opening 2050 of the first receiving chamber to form a sealed space 2045. The space 2045 is not sealed by itself, but located in the sealed space 2054. Therefore, the space 2045 of the first chamber constitutes an overall sealed space 901 with the space 2054 of the second receiving chamber (FIG. 13). If the first receiving chamber moves downwards in the second receiving chamber, the volume of the sealed chamber 2054 reduces, and gas therein is compressed; the compressed gas will flow into the first receiving chamber 2045 via the hole 2055 on the end portion of the first receiving chamber to increase the air pressure in the chamber 2045. The rising air pressure will enable the piston 18 to move from the initial closed position to the opened position, and the gas will flow into the channel 111 via the piston chamber 21 to be discharged into the air. Of course, when the internal pressure and the external pressure are balanced after the gas is discharged, the piston will get back to the initial closed position due to the elastic force of the spring. When the first chamber continues to move, the piercing structure located on the end portion of the first chamber will pierce the chamber 2036 located at the bottom of the second receiving chamber, such that the sample treatment liquid in the chamber 2036 will flow into the first chamber, for example, flow into the chamber 2045 to contact the absorbing element 20. In this way, the sample on the absorbing element is eluted, diluted, dissolved and the like to form a mixed solution. The mixed solution includes a sample and a treatment liquid. The first chamber continues to move such that pressure in the overall sealed chambers (2054,2045) rises; and a pressure is applied on the liquid; the pressure will also make the position of the piston 18 changed and make the piston 18 being in an opened state. The liquid sample or mixed solution will flow into the channel 111 via the piston chamber 21, and thus flow into the carrier 101 via the channel to contact the testing element, thus completing the detection or assay of the analyte in the sample.

In some embodiments, when the collector is inserted into the first receiving chamber, the absorbing element 20 is located in a sealed space, and the sealed space includes a space 2045 and the space 2054 of the second chamber sealed by the first chamber. At this time, the end portion 203 of the collector seals the opening 2050 of the first receiving chamber. When the end portion 203 continues to move downwards in the first chamber 200 to drive the first chamber to move in the second chamber, the movement of the end portion 203 and the movement of the first chamber in the second chamber make the gas in the sealed space compressed, causing increased pressure therein. The movement of the end portion makes the absorbing element squeezed to release liquid in the space 2045, for example, flowing into the chamber 2037. The rise of pressure inevitably urges the piston 18 to move from the initial closed state to the base 16, thus being in an opened state. In this way, gas, or liquid in the sealed space is allowed to flow into the channel 111 via the piston chamber 21, and then flow to the testing element on the carrier 101.

It may be understood that the separate movement of the end portion 203 of the collector will also increase the pressure in the space; the separate movement of the first chamber in the second chamber may also increase the pressure of the sealed space, or the associated movement of the end portion and the first chamber may also increase the pressure in the sealed space. In some embodiments, the movement of the first chamber in the second chamber refers that the end portion of the collector is inserted into the first chamber to drive the first chamber to move in the second chamber.

### Controlling Element

The problem that the controlling element may control the fluidic communication between the absorbing element and the testing element has been described previously, and here the problem will be described again in combination with operations. Further, problems on how to combine with the controlling element, the absorption of the absorbing element on samples, compression, mixing and increase the pressure will be described, for example, described in FIGS. 12-14. In some embodiments, the present invention provides a test device; the device includes a testing element 112; the testing element is located in the carrier 101. During assembly, the testing element is disposed in the groove 1115, where the tail end of the sample application area 1121 leans against the baffle 1114 (as shown in FIG. 17). Of course, if there are a plurality of grooves, there are a plurality of testing elements 112, and each testing element is directed to an analyte. In a detailed embodiment as shown in FIG. 17, the testing element 112 is disposed in the groove 1115. A film 114 is covered on the surface of the carrier, and the film is covered on the groove, and covered on the recessed area 1116 and an inlet 1117, that is, covered on the surface of the overall carrier 101. In this way, the testing element is located in a space on the carrier. A through hole 1017 is disposed at the bottom of the recessed area 1116 of the carrier; and the through hole is communicated with the atmosphere. The carrier 101 has an area 1018 on the back, and the area is provided with a water absorbing paper used for absorbing the excessive liquid. During assembly, the carrier is inserted into the housing 702 such that one end 13 of the collector 103 is connected with the guiding tube 117 on the carrier. Another end of the end portion is provided with an absorbing element 20 and has an end portion 203. The end portion includes a piston chamber 21; the piston chamber is provided with a piston and a spring, such that the test device in a detailed embodiment of the present application is assembled (as shown in FIGS. 12A-12B). In this device, the absorbing element 20 is not in direct communication with the channel 111. In this way, when the sample is collected, liquid will not flow into the channel 111 in advance due to other conditions and then flow onto the testing element 112 of the carrier 101.

A receiving chamber is provided. The receiving chamber includes a first receiving chamber 200, used for receiving the insertion of the absorbing element. The first receiving chamber is located in the first position (as shown in FIG. 12) of the second receiving chamber 10. In this way, a sealed space 2054 is formed in the first receiving chamber. The first receiving chamber has an opened end 2055 and provided with a piercing element (not shown). The first receiving chamber has two chambers, namely, a chamber 2035 used for receiving the absorbing element, and another chamber 2037 communicated with the chamber. There is a step between the chambers with two different cross sections, and the step is used for squeezing the platform 2089 of the absorbing element. Moreover, a sealed chamber 2036 is disposed at the bottom of the second chamber 200 and upstream of the through hole 2055 of the second chamber, and a treatment liquid is reserved therein, and the chamber is sealed by a film 80 (as shown in FIG. 9).

During use process, the absorbing element 20 is used in a mouth to be detected to collect saliva samples; when enough amount of samples or saliva samples are collected, one end of the test device with the absorbing element is inserted into the chamber 2035 of the first receiving chamber. When the absorbing element is inserted, the end portion 203 of the collector will also enter to the chamber 2035, and the end portion 203 of the collector will contact the inner wall 2095 of the first receiving chamber, thus sealing the opening 2050 of the first receiving chamber. The sealing way is that the elastic scaling ring 15 on the end portion contacts the inner wall 2095 of the first receiving chamber. In this way, the first receiving chamber forms a sealed space 2054 in the second receiving chamber. In this way, the chamber 2045 of the collector in the first receiving chamber (although the through hole is communicated with the sealed space 2054) is in a sealed space; or the space 2054, and the spaces 2045,2037 in the first receiving chamber form a sealed space 901. As shown in FIG. 13, at this time, the end portion 184 of the piston is located in the sealed chamber of sealed space 901. (the sealed chamber 2054 and chamber 2045 are uniformly called a scaled chamber). The piston 18 is located in the piston chamber 21, and the piston chamber 21 is in fluidic communication with the channel 111. However, the piston 18 is located in the piston chamber to achieve the sealing of the piston chamber, or to block the fluidic communication between the sealed space and the channel 111. In some embodiments, there is a certain distance between the end portion 184 of the piston and the inner wall of the first receiving chamber to form a space 189 between the end portion 184 and the inner wall of the first receiving chamber; in this way, gas or liquid in the space 2054 flows into the space 189 to exert a pressure on the end portion 184 of the piston. Under such a state, when the absorbing element is compressed to release the liquid sample, and the end portion 203 of the collector continues to move downwards in the first receiving chamber (the first receiving chamber may move downwards or does not move in the second receiving chamber), the gas in the whole sealed space 901 is compressed, and the gas pressure in the sealed space rises to be higher than the atmospheric pressure generally. Accordingly, the gas pressure in the sealed space rises to exert a pressure on the end face 184 of the piston. The pressure overcomes the counter-acting force of the spring, that is, the piston changes from the initial state (the piston chamber is closed) into the state of opening the piston chamber. In this way, gas in the sealed chamber will flow into the channel 111 from the opened piston chamber 21 and flow into the carrier 101 containing testing element, then the gas is discharged to the air via the hole 1017 on the carrier. It may be understood that even if there is liquid in the chamber 2045, the liquid may also be located in the chamber 2045 or in another chamber 2037 communicated therewith. Gas is always located above the liquid. Therefore, gas in the sealed space is generally discharged firstly. Once the pressure in the sealed chamber is equal to the ambient pressure after discharging the gas, the spring enables the piston 18 to restore the initial position from the opened position by the rebound force to seal the piston chamber 21, thus blocking the communication of the fluid in the sealed chamber with the channel 111.

As the end portion 203 continues to move in the first chamber, on the one hand, the movement squeezes the absorbing element such that the liquid sample absorbed on the absorbing element may be squeezed and released as much as possible. The squeezing of the absorbing element is to reply on the movement of the end portion 203 of the collector in the first chamber to reduce the space and give more pressure on the absorbing element. In this way, the liquid sample of the absorbing element may be squeezed out, and the squeezed sample may be remained in the chamber 2045, and also may flow into the chamber 2037. The end portion 203 moves downwards in the first receiving chamber, which drives the first chamber to move in the second chamber. In this way, under double action, the volume of the sealed space will be also compressed to discharge the excessive gas. Moreover, the first chamber 20 moves in the second chamber 10 such that the piercing element on one end 2055 of the first chamber pierces the chamber 2034 sealed with a treatment liquid in the second chamber. In this way, the treatment liquid flows into the first chamber, for example, flows into the chamber 2037 or chamber 2045 in the first chamber. The treatment liquid may regulate the PH value of the liquid sample, or elute the absorbing element, such that the analyte of the sample is dissolved into the treatment liquid as much as possible. In case of a saliva sample, the saliva is viscous or has small amount, and the treatment liquid plays a dissolving role. The treatment liquid here functions to improve the detection properties of the sample, but the treatment liquid contains no analyte.

In practice, when the piercing element is inserted into the chamber 2034 of the treatment liquid, the volume of the sealed chamber 2054 is also decreased. At this time, pressure in the sealed chamber 2054 rises, and the rising air pressure will be passed to the treatment liquid in the chamber 2034 such that the treatment liquid fully flows into the first chamber as soon as possible. Under the action of the pressure, the treatment liquid flows into the first chamber. At this time, the first chamber constitutes a separate sealed chamber; the hole 2055 at one end of the piercing element is sealed by the treatment liquid, and another end is sealed by the end portion 203 of the collector, but the pressure can be passed between the scaled chamber 2054, the sealed chamber 2045 and the chamber 2037. In this way, fluidic communication between the first sealed chamber 2054 and the second sealed chamber 2045 may be achieved. The communication is transferred based on the different pressure between the two sealed chambers. If the pressure in the first sealed chamber 2054 rises, the rising pressure urges the liquid containing the treatment liquid to flow into the second sealed chamber 2045 as soon as possible and also increases the pressure in the chamber 2045. The rising pressure urges the piston 18 to change in position such that the piston chamber 21 is communicated with the sealed space 2045, thus discharging the gas to the channel 111 and decreasing the pressure in the sealed chamber 2054. The rising pressure (air pressure) in the sealed chamber 2054 urges the treatment liquid to flow into the sealed chamber 2045. In this way, the treatment liquid is fully mixed with the sample, or fully contacts the absorbing element, thus eluting the analyte which is possibly absorbed on the absorbing element.

In some embodiments, for example, gas is discharged, for instance, gas in the sealed chamber 2045 is discharged, and the liquid sample or the mixed solution of the liquid sample and the treatment liquid are remained substantially. At this time, if the end portion 203 of the collector continues to move downwards, a pressure is applied on the liquid. Such a pressure refers that the mechanical pressure is directly applied on the liquid, and moreover, the volume of the sealed chamber 2054 is narrowed to increase the pressure. The liquid is compressed under the increase of dual pressures. To achieve a balance between the pressure in the seal chamber and the air, for example, a pressure balance in the channel 111, the pressure in the sealed chamber will urge the piston 18 to move towards the direction close to the piston base. In this way, the piston column 181 of the piston and the piston limiting part 183 are away from the piston chamber 211 to move on the inner wall of the piston chamber 211; in this way, the piston chamber is communicated with the sealed chamber such that the liquid flows into the channel 111 via the piston chamber. Liquid in the channel will flow to the carrier to contact the testing element in the carrier. Specifically, liquid flows into the sample application area 1121 of the testing element to flow through the testing area 1125 and the test result control area 1124 in order, and then flows into the absorbing area 1123, thus completing the assay of the analyte in the sample.

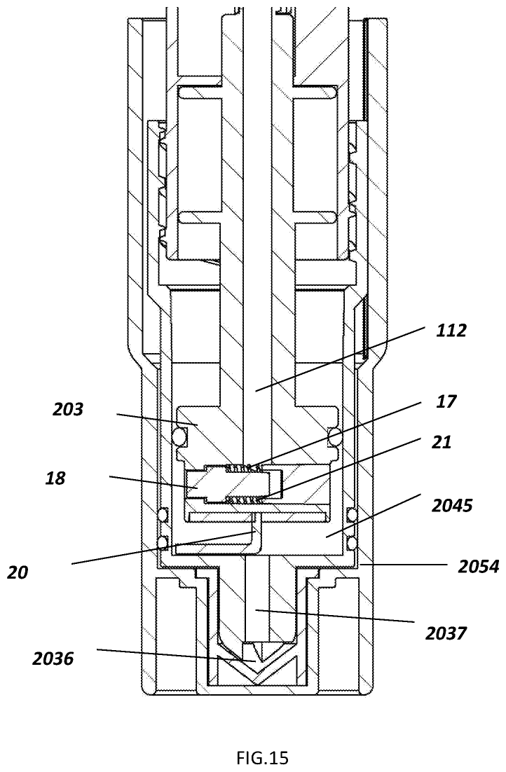

Once the pressure in the sealed chamber is balanced with the pressure in the channel 111, for example, gas pressure or liquid pressure, the piston will automatically get back to the initial position (FIG. 15) under the rebound force of the spring. In this way, the piston chamber 21 is closed to cut off the fluidic communication between the sealed chamber 901 and the channel 111, and of course, the communication between the sealed chamber and the chamber containing the testing element is also cut off. It may be understood that the piston may be repeatedly closed or opened.

The testing element is not always in the chamber, and may be located in the atmospheric environment. Actually, the essence is that there is a pressure difference between the space where the absorbing element is located and the channel on the collector; the piston or controlling element is used to connect the space where the absorbing element is located with the outer space, for example, the communication properties with the channel on the collector. In this way, the change between the space where the absorbing element is located and the outer space will cause the movement of a valve or a piston. Such a communication or control relation is merely described in the present invention via the movement of the piston, and of course, there are other similar structure deigns. For example, it is a valve, when the pressure in the sealed space increases, the valve will be opened automatically; when the pressure in the sealed space decreases or is balanced with the outer space, the valve will be closed automatically. Such a valve is similar to a one-way valve; gas or liquid only flows unidirectionally under pressure, for example, flowing to a low-pressure site from a high-pressure site. In this present invention, gas or liquid in the sealed space containing the absorbing element flows into the low-pressure place beyond the sealed space via the valve. Such a valve is also disposed in an end portion area of a collector.

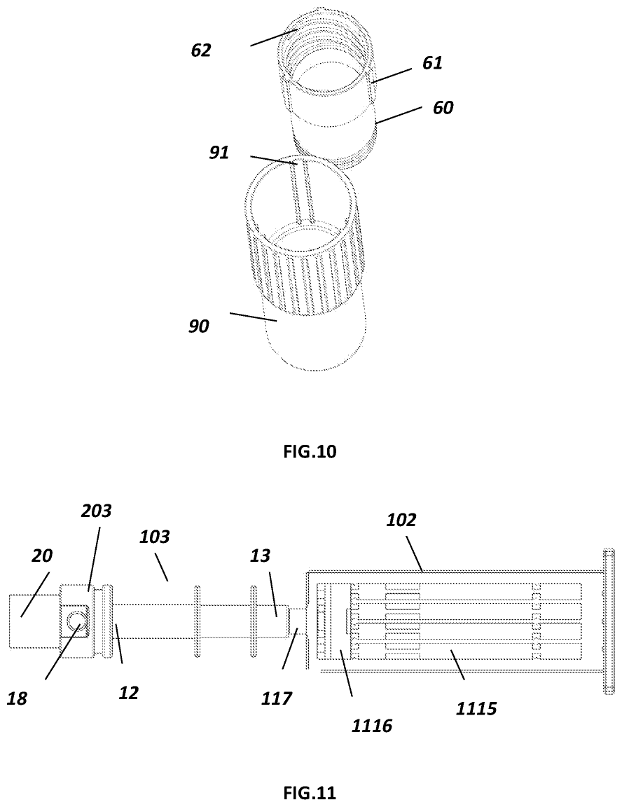

In some embodiments, the first receiving chamber 60 moves in the second receiving chamber 90, and also a connecting tube 1101 on the housing 702 is inserted into the first receiving chamber. Threads on the surface of the connecting tube 1101 are in screw thread fit with the first receiving chamber 60. In this way, the connecting tube 1101 rotates into the first receiving chamber; the connecting tube is integrated with the first receiving chamber. Once the threads are exhausted, the tube is kept in a fixed position in the first receiving chamber 60. In the position, the end portion of the collector also enters into the first receiving chamber to form a space therein. Moreover, the absorbing element is also compressed to release the liquid sample. As described above, for example, as shown in FIG. 10, the movement of the first receiving chamber in the second chamber is achieved when the collector 1101 drives the first receiving chamber to move, thus achieving the increase of the pressure in the sealed space. Alternatively, the chamber containing the treatment liquid located in the second receiving chamber is pierced to enter into the first receiving chamber.

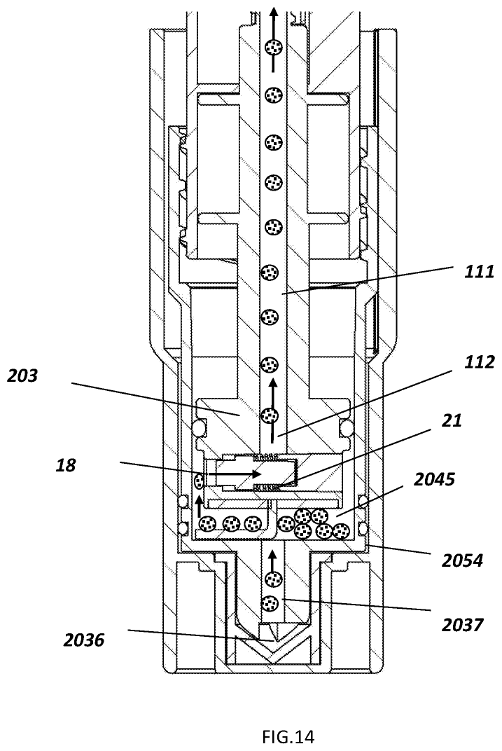

When the absorbing element 20 is inserted into the first receiving chamber 200, an clastic sealing ring is disposed on the end portion 203 of the collector. In that way, when the absorbing element enters into the first receiving chamber, the absorbing element is in a relatively sealed state. The sealing produced by matching the clastic sealing ring 15 with the inner wall of the first receiving chamber is mainly to avoid that the liquid flows out from the gap between the end portion of the collector and the first receiving chamber 2095. When such kind of sealing is formed, even if the absorbing element is not compressed, air may be compressed, such that a stronger force needs to be applied to push the absorbing element to move downwards, thereby performing the compression of the subsequent absorbing element. In any case, air compression may be produced internally to increase internal pressure. Therefore, in order to further push the end portion 203 of the collector to move downwards easily or smoothly, the controlling element (valve, piston and the like) is opened automatically under air pressure to discharge excessive gas, which facilitates that the absorbing element is inserted. In case of no sealing ring, when the absorbing element is fast inserted, there is a possibility to produce pressure locally within short time (compressed air). Specifically, as shown in FIGS. 13-14, when inner wall of the first receiving chamber 2095 is sealed by the sealing ring 15, as the end portion 203 of the collector moves downward, air or gas in the first chamber is compressed. At this time, the absorbing element may be not compressed, but produces an increased pressure internally, the air is compressed. It needs to discharge excessive air at this time to ensure a balance between internal and external pressure. The increased pressure will open the controlling element, for example, opening the piston 18, such that excessive air is discharged into the channel 111 via the controlling element, and thus discharged to the atmospheric environment, for example, discharged to the atmospheric environment via a channel 1107 of the carrier. At this time, the function of pressure removal is convenient for the end portion to further compress the absorbing element; if the pressure is not removed, a stronger force is required to push the end portion to move.

In practice, it is easy to distinguish the compressed state of the absorbing element from the uncompressed state of the absorbing element. Whether liquid flows may be controllable, which avoids the problems of reaction in advance, or incorrect result caused by insufficient treatment or non-finished treatment on the sample. If the operating step is controllable, the above problems may be avoided.

Similar to the above situation, when gas or liquid exerts a force on the piston element, the piston overcomes the elastic force of the spring to open the opening, thus discharging the gas or making the liquid flowing through and into the channel 111. When a fluid sample is collected, for example, saliva is collected by the absorbing element, the valve element is in the closed state without external force. At this time, the fluid sample will not flow to the channel 111 and thus not flow onto the testing element of the carrier for detection or array in advance. Moreover, when the absorbing element is inserted into or pushed into the first chamber of the receiving device, the space of the absorbing element is compressed to discharge excessive gas, making the collector continuously moving in the first chamber easily; and when the absorbing element is continuously pushed, the absorbing element is compressed, and the liquid has a pressure to exert on the piston, such that the piston is in an open state and liquid flows to the channel, and then flows to the carrier and contacts with the testing element, for example, a horizontal testing element, thus performing array or reaction of the analyte in the fluid sample. When the inside and outside pressure is balanced (gas pressure or liquid pressure), the valve is closed automatically, such that the space where the absorbing element is located may be not in fluidic communication with the testing element.

### Change of State of the Absorbing Element

When a fluid sample is collected by the absorbing element, the absorbing element may be inserted into the first receiving chamber 200 for eluting, mixing or treating the mixed solution. The treated fluid sample, or the solution containing the sample after eluting the absorbing element flows to achieve the final assay. The receiving device generally includes a first chamber 200 and a second chamber 10, and the first chamber may be moved. In some embodiments, such kind of moving refers that the absorbing element is pushed or moved during, before or after being inserted into the first chamber. The first chamber may be a mode of test tube, and the first chamber has a piercing element, and the sealed chamber of the treatment fluid in the seal chamber is pierced such that the mixed solution in the sealed chamber 2036 flows to the first chamber 200.

When the absorbing element is inserted into the first chamber, the absorbing element has a compressed and uncompressed state in the first chamber; the two states of the absorbing element may be relevant or not relevant to the position state of the first chamber. For example, when the absorbing element is not compressed, the first chamber may be located in the first position, and the position is the initial position of the first chamber. Under such a position, the sealed chamber 2036 in the second chamber will be not pierced by the piercing element on the first chamber. Of course, in an optional embodiment, when or after the absorbing element enters to the first chamber and is in the uncompressed state, the first chamber has pierced or simultaneously pierces the sealed chamber 2036 in the second chamber, such that the mixed solution flows to the first chamber and contacts with the absorbing element. At this time, the first chamber and the second chamber change in the position. Generally, the first chamber changes to the second state or the second position from the initial position; and the change of position is achieved by pushing the change of the first chamber via the absorbing element.

Optionally, when the absorbing element is in the compressed state, or when or after the absorbing element changes to the compressed state from the uncompressed state, the first chamber has pierced or simultaneously pierces the sealed chamber 2036 in the second chamber, such that the mixed solution flows to the first chamber and contacts with the absorbing element.

In some embodiments, for example, as shown in FIGS. 10 and 11, the absorbing element 20 is used to absorb the liquid sample. One end of the connecting rod containing the channel 111 is connected with the absorbing element, and another end is connected with the carrier, thus achieving fluidic communication between the absorbing element and the testing element on the carrier. Such kind of communication is a controlled or controllable communication, as mentioned above. To achieve the compressed and uncompressed states of the absorbing element 20, as shown in FIG. 13, when the absorbing element is inserted into the first chamber, the opening of the first chamber is butted against the extending tube 1101 of the carrier element along with 2050, thus preventing the further movement of the tube. It may be configured below, the opening of the tube 1101 is subjected to the length of the collector, namely, the connecting rod 11, total longitudinal length of the end portion 203 and the absorbing element 20, is less than the distance from the opening 2050 of the first receiving chamber to the contact platform 2089. In this way, when the absorbing element is inserted into the first chamber, the tube 1001 is butted against the opening of a chamber along with 2001 to prevent the entry of the absorbing element, thus keeping the absorbing element in the uncompressed state.

Such kind of mutually blocked structure may be achieved by any structure, for example, a screw thread 705 is disposed on the tube 1101, and the first chamber is substantially meshed with a screw thread; when insertion is selected, screw threads are mutually meshed (in the case of no mutual rotation); such kind of meshed condition brings a possibility that the tissue absorbing element is compressed. That is, when the absorbing element is inserted into the first chamber, only the action of insertion without rotation of the first chamber may achieve that the absorbing element is in the uncompressed state. When compression is required, the absorbing element is compressed only by the mutual rotation of the screw thread of the tube 1101 and the screw thread of the first chamber (FIG. 10). To achieve the function better, as shown in FIG. 10, the first chamber 60 is matched with the external second chamber 90 via a sliding rail, that is, the first chamber has a protruding sliding rail 61 on the outer wall which is matched with a sliding chute 91 of the second chamber 90. Under such a condition, the first chamber 60 only moves up and down in the second chamber 90, and mutual rotation is not allowed during the moving process. When mutual rotation is required, for example, the absorbing element mutually rotates relative to the first chamber; such kind of rotation is the meshed rotation of screw threads 62 of the tube 1101 and the first chamber, thus driving the absorbing element to move downwards and contacting with the platform 2089, achieving compression. During the meshed rotation, the first chamber may hardly move due to the control of the sliding rail and the sliding chute. The downward movement of the absorbing element is achieved by the rotation of the tube 1101 in the first chamber. By this way, when the absorbing element is in the uncompressed state, the first chamber slides to make the piercing element thereon piercing the sealed chamber 2036 in the second chamber, thus releasing the mixed solution to the first chamber and in contact with the absorbing element. The contact time may be controlled freely, for example, 1-5 min, even any time, such that the mixed solution is in full contact with the absorbing element, thus achieving full reaction.

When necessary, the absorbing element is compressed by the rotation of the tube 1101 and the first chamber and the meshed screw thread. During or after the compression, the fully reacted mixed solution (containing the fluid sample) flows into the channel 111 via the controlling element, and thus flows into the groove of the carrier and onto the testing element for testing or assaying whether the sample contains the target analyte.

In some embodiments, since the detection apparatus is mainly used for roadside detection, such as drug driving, or public places, it is desirable to operate conveniently and not to leak out the liquid samples. To avoid contamination and/or to quickly obtain test results, it is desirable that the liquid samples or body fluid treated quickly pass through the absorbing element to enter the carrier and contact the testing element. The treated liquid or liquid samples, or mixture of liquid sample and the treated liquid; or, the treated liquid directly pass through the absorbing element (when the absorbing element is not compressed) quickly, or directly enter the carrier to contact the testing element without passing through the absorbing element. In order to achieve one or more of the above purposes, a sealed space 2054 is formed between the first chamber 200 and the second receiving chamber 10 accommodating the first chamber, and the sealed space can be compressed. Preferably, the closed space 2054 is communicated with the first receiving chamber. Such a communication may be achieved via a hole 2055 on one end of the first receiving chamber. When the first receiving chamber is sealed, the scaled chamber 2054 forms a sealed space together with the chamber 2045 in the first receiving chamber. The piercing element is disposed on one end of the first receiving chamber containing the hole; the piercing element may pierce the sealed chamber 2036 located in the first receiving chamber; the sealed chamber contains a solution for treating a sample. Preferably, the chamber 2036 is sealed by a sealing film, but the film is easily pierced to release the treatment liquid. Of course, a piercing piece can be placed between the first chamber and the treated liquid chamber, to pierce the film that seals the chamber of the treated liquid. The sealed space 2054 between the first chamber 200 and the chamber 10 may be achieved through the elastic scaling rings 2040,2041 disposed on the first chamber. As the pressure increases, after the sealed chamber 2036 is pierced, the channel 2055 on the piercing element comes into contact with the liquid, and the treated liquid automatically flows back to the first chamber under pressure. At this time, there are liquid samples or an absorbing element in the first chamber, the treated liquid is mixed with the liquid sample or contacts with the absorbing element, to complete the treatment of the treated liquid. At this time, if the end portion with the absorbing element is also sealed with the inner wall of the first chamber 60, the treated liquid or the treated liquid passing through the absorbing element easily flows into the channel of the connecting rod 111 smoothly. At this time, the absorbing element can be further compressed. Since the end portion and the inner wall of the first chamber are in a sealed state, the compression of the absorbing element 20 also increases the pressure of the space scaled by the end portion 203, which is more advantageous for the treated liquid that pass through the absorbing element to flow into the channel of the connecting rod, allowing the liquid to flow into the test strip, to complete the detection. The flow here is still controllable, as mentioned in the above solution.

The operation method of the present invention will be described with reference to FIGS. 12-14, specifically as follows: in specific operation, as shown in FIG. 12A, a testing element 112 and an absorbing element 20 are provided; the absorbing element is located on one end of the collector 103, and the end portion 203 of the collector is provided with a controlling element, for example, a movable piston 18. The piston is provided with a spring 17; the spring is compressed by the piston. In this way, the rebound force of the spring makes the piston sealing the chamber 211 on one end of the piston chamber 21. One end of the piston chamber is sealed, and another end thereof is communicated with the channel 111 on the collector. The channel 111 on the collector is communicated with the space in the carrier 101 where the testing element 112 is located; the space of the carrier is communicated with the outer space via a hole 1017. In the initial stage, the space where the absorbing element is located and the space where the testing element is located are in the atmospheric environment. One end of the piston channel is sealed by the piston 18. In this way, the liquid sample absorbed on the absorbing element 20 may not flow into the channel 111 directly, and not flow onto the testing element directly. When the absorbing element and the testing element are in different spaces and there exists a pressure difference between the space of the absorbing element and the space of the testing element. The pressure forces the piston to move from the initial closed position to the position where the piston chamber is in fluidic communication with and the space where the absorbing element is located. It is believed that the piston blocking is to block the fluidic communication between the space where the absorbing element is located and the piston chamber 21 in practice. The present invention provides a first receiving chamber 200 for receiving the absorbing element, and a second receiving chamber 10 for receiving the first receiving chamber. In the detailed example, the first receiving chamber 200 is located in the second receiving chamber to form an independent space 2054 in the second receiving chamber. Two chambers 2035 and 2037 in the first receiving chamber are in fluidic communication with the space 2054. As shown in FIG. 13, when the absorbing element is inserted into the chamber 2035 of the first receiving chamber at any time, the opening 2050 of the first receiving chamber is sealed by the end portion 203 of the collector. In this way, a sealed space 901 is produced in the space formed between the first receiving chamber and the second receiving chamber. At this time, the space sealed by the collector consists of chambers 2045,2037 and 2054. Pressure in the sealed space will increase as long as gas in any one of the three spaces is compressed. As described above, the housing 702 for accommodating the carrier has a tube 1101, and the tube has screw threads 705 on the outer surface thereof. When the screw threads on the outer surface of the tube are meshed with the screw threads in the first receiving chamber, an integrated structure is formed with the first receiving chamber. At the beginning of the meshing process, the absorbing element may be compressed, and of course, the absorbing element may be compressed after the meshing. As shown in FIG. 13, the absorbing element 20 is not compressed at this time. When the external threads 705 are continuously meshed and rotated with the internal threads of the first receiving chamber to drive the end portion to move downwards, the absorbing element 20 is compressed in this way. Therefore, the liquid sample absorbed on the absorbing element is released to the space 2045, and of course may flow into the space 2037. During the process of moving downwards, the end portion 203 inevitably increases the pressure in the sealed space 901, and gas is compressed. In this way, the pressure in the space where the absorbing element is located increases, and the increased pressure forces the piston to move towards the right. The piston chamber 201 is opened such that the excessive gas is discharged to the channel 111 from the piston chamber 21. As the gas is discharged, the pressure in the sealed space where the absorbing element is located is gradually equal to or substantially equal to the pressure of the outside world, for example, pressure in the channel 111, or when the rightward force on the piston is equal to or less than the rebound force of the spring 17, the piston moves towards the left to the position again which seals the piston 21. The rightward movement of the piston is achieved by the increased pressure in the internal sealed space. In the above process, as the end portion moves downwards to drive the first receiving chamber to move downwards from the initial position in the second receiving chamber, the movement may make the piercing element piercing the sealed chamber 2036, such that the treatment liquid flows into the chamber 2037 or 2045 from the chamber 2036 via the hole 2055. As described above, two sealed spaces are formed in this way; one is the chamber 2054 (first sealed space), and another is a sealed space (second sealed space) composed of the chamber 2045 and the chamber 2037. The two sealed spaces are communicated via the hole 2055 entering into the chamber 2036. In this way, when the pressure in the sealed chamber 2054 increases, the increased pressure will be passed to the liquid in the chamber 2036 certainly, which forces the treatment liquid to flow into the second sealed space. In this way, the treatment liquid is mixed with the liquid sample in the second sealed space to form a mixed solution (as shown in FIG. 14); the pressure in the two sealed spaces is increased to finally increase the pressure in the second scaled space. If gas has been discharged, the increased pressure also urges liquid to be discharged. In this way, the piston is forced by the liquid sample or mixed solution to move rightwards, thus making the liquid flowing to the channel 111 from the piston chamber 21. Accordingly, the liquid flows into the recessed area of the carrier 101, and partial liquid will contact the testing element, thus completing the analysis or assay of the analyte in the mixed solution. The process of discharging gas is also a process that the pressure in the sealed space of the absorbing element is substantially equal to the pressure of the outer space. Alternatively, during the process of discharging gas, when the pressure of the increased pressure on the piston 18 is less than or equal to the counter-acting force of the spring on the piston, the piston chamber 21 is closed by the piston. In this way, the volume of the liquid flowing into the channel 111 is quantitative. This is because the compressed sealed space has a constant volume, and the increased pressure is the same. Therefore, during the operation, the volume of the liquid discharged of each test device is constant, thus ensuring a constant liquid volume in the detection of each test device.

What is described above is to describe the operation process of a detailed example, and did not construed as limiting the scope of the present invention. The scope of the present invention shall be the claims.

In some embodiments, the following detailed embodiments are also a portion of the present invention.

1. A device for detecting whether an analyte is contained in a fluid sample, wherein the device comprises an absorbing element used for absorbing the fluid sample and a testing element, and wherein fluidic communication between the testing element and the absorbing element is capable of being controlled.

2. The device according to clause 1, wherein the control comprises a step of automatically blocking the fluidic communication between the testing element and the absorbing element or automatically changing a blocking state into a communicated state.

3. The device according to any one of clauses 1-2, wherein the device further comprises a controlling element, and the fluidic communication between the testing element and the absorbing element is achieved by the controlling element; preferably, the controlling element is automatically closed or opened to achieve the automatic control of the fluidic communication or fluidic non-communication between the space where the absorbing element is located and the space where the testing element is located.

4. The device according to clause 3, wherein when the controlling element is in a first state, the absorbing element is not in fluidic communication with the testing element, and when the controlling element is in a second state, the absorbing element is in fluidic communication with the testing element.

5. The device according to clause 3, wherein the controlling element is capable of being opened or closed; when the controlling element is in a closed state, the absorbing element is not in fluidic communication with the testing element, and when the controlling element is in an open state, the testing element is in fluidic communication with the absorbing element.

6. The device according to clause 5, wherein the being opened or closed comprises being automatically opened or automatically closed.

7. The device according to clause 6, wherein the controlling element is automatically opened or closed under the change of a liquid pressure or an air pressure.

8. The device according to clause 7, wherein the pressure is air pressure; when the controlling element is compressed by air, the controlling element is opened to discharge excessive gas.

9. The device according to clause 7, wherein the pressure is liquid pressure; when the controlling element is compressed by liquid, the controlling element is opened to discharge the liquid.

10. The device according to any one of clauses 5-9, wherein the testing element is located in the second space; the absorbing element is located in the first space; a pressure change between the first space and the second space makes the controlling element opened or closed automatically; preferably, the pressure in the first space is higher than the pressure in the second space such that the controlling element automatically changes into the opened state from the closed state.

11. The device according to clause 10, wherein the device further comprises a chamber for accommodating the absorbing element; when the absorbing element is located in the chamber, the second space is formed in the chamber; preferably, the chamber is a sealed chamber; preferably, the second space is a sealed space; preferably, there exists a pressure difference between the scaled chamber and the space where the testing element is located; the pressure difference enables the controlling element to be automatically opened or closed; preferably, the space where the testing element is located is unsealed; preferably, the unsealed chamber is communicated with the atmospheric environment.

12. The device according to clause 11, wherein the pressure in the chamber for accommodating the absorbing element is higher than the pressure in the space where the testing element is located, the pressure in the chamber for accommodating the absorbing element enables the controlling element to be opened automatically; or, when the pressure in the chamber for accommodating the absorbing element is substantively equal to the pressure in the space where the testing element is located, the controlling element is closed automatically.

13. The device according to clause 11, wherein an increase of the pressure in the chamber for accommodating the absorbing element is achieved by compressing a gas or a liquid in the chamber such that the pressure in the chamber is higher than the pressure of the second space where the testing element is located.

14. The device according to clause 11, wherein the chamber is located in a first receiving chamber, and the first receiving chamber has an opening; when or after the absorbing element is inserted into the first receiving chamber, the opening of the first receiving chamber is sealed such that the absorbing element is located in a sealed chamber.

15. The device according to clause 7, wherein after or when the absorbing element is inserted into a first space, the space is sealed, and a gas pressure in the space rises, or a liquid pressure in the space rises; preferably, when the absorbing element is inserted, gas in the space is compressed to increase the pressure in the scaled space; preferably, the testing element is located in the first space.

16. The device according to clause 15, wherein the space is located in the first receiving chamber, the first receiving chamber is located in a second receiving chamber, and the first receiving chamber is capable of moving in the second receiving chamber.

17. The device according to clause 16, wherein the moving of the first receiving chamber in the second receiving chamber is capable of increasing a gas pressure or a liquid pressure in the first space.

18. The device according to clause 15, wherein the second receiving chamber comprises a third receiving chamber; the third receiving chamber comprises a reagent for treating a liquid sample.

19. The device according to clause 3, wherein the absorbing element is connected to the testing element via a channel such that the fluidic communication is achieved by the channel, wherein the controlling element is located in the channel.

20. The device according to any one of clauses 1-19, wherein the controlling element comprises a piston and a spring, or a valve.

21. The device according to clause 20, wherein the piston has a first position and a second position in the channel; when the piston is located in the first position, the channel is closed by the piston; when the piston is located in the second position, the channel is opened by the piston.

22. The device according to clause 21, wherein when the spring is located in a first state, the piston is located in the first position; when the spring is located in a second state, the piston is located in the second position.

23. The device according to clause 22, wherein switching of the piston between the first position and the second position is achieved automatically by a change of a liquid pressure or an air pressure applied on the piston.

24. The device according to clause 23, wherein when the pressure on the piston is higher than a rebound force of the spring applied on the piston, the piston is located in the second position; when the pressure on the piston is less than or equal to a rebound force of the spring applied on the piston, the piston is located in the first position.

25. The device according to clause 24, wherein when the piston is located in the second position, the channel is opened by the piston, thus discharging gas or liquid.

26. The device according to clause 25, wherein the discharged liquid flows onto the testing element via the channel.

27. The device according to clause 26, wherein the liquid comprises a liquid sample, or a liquid sample mixed with a treatment liquid.

28. A device for detecting whether an analyte is contained in a fluid sample, comprising:
a first receiving chamber, used for receiving an absorbing element for absorbing the fluid sample, and
a testing element located outside the chamber;
wherein the chamber is communicated with the testing element via a channel; when the absorbing element is inserted into the chamber, a first sealed space containing the absorbing element is formed in the chamber, wherein a piston or a valve is arranged in the channel; the piston or the valve has a first state or a second state; when the piston or the valve is in the first state, the channel is sealed; when the piston or the valve is in the second state, the channel is opened.

29. The device according to clause 27, wherein when a pressure in the first sealed space is higher than a pressure of a space where the testing element is located, the pressure automatically enables the piston to change into the second state from the first state.

30. A device for detecting whether an analyte is contained in a fluid sample, comprising:
a first receiving chamber, used for receiving an absorbing element for absorbing the fluid sample,
a second receiving chamber, wherein the first receiving chamber is located in the second receiving chamber; and a testing element, wherein the testing element is located in a carrier, and a collector integrated with the carrier, wherein the collector contains a channel, and one end of the channel is in fluidic communication with the testing element on the carrier, and another end of the channel is provided with an end portion, and the end portion is provided with an absorbing element, and wherein the end portion is further provided with a piston chamber for the arrangement of a piston; one end of the piston chamber is communicated with the channel, and another end of the piston chamber is sealed by the piston.

31. The device according to clause 30, wherein when the absorbing element is inserted into the first receiving chamber, a sealed space is formed in the first receiving chamber; a change of the pressure in the sealed space or a change of the pressure in the sealed space and the channel enables the piston to change in position automatically; the automatic change of position enables one end of the piston chamber to be in a sealed or unsealed state.

32. A device for detecting whether an analyte is contained in a fluid sample, comprising:
an absorbing element used for absorbing the fluid sample;
a testing element used for testing whether an analyte is present in the sample;
wherein the absorbing element is located in a first space, and the testing element is located in a second space; the first space is in fluidic communication with the second space via a channel, and wherein the channel is provided with a controlling element; a pressure change between the first space and the second space makes the controlling element being in an automatically opened or closed state.

33. The device according to clause 32, wherein when the controlling element is automatically opened, fluidic communication between the first space and the second space is capable of achieved via a channel; when the controlling element is automatically closed, the first space may be not in fluidic communication with the second space.

34. The device according to clause 32, wherein the pressure difference between the first space and the second space enables the controlling element to be in a closed or opened state.

35. The device according to claim 32, wherein the first space is a sealed space; and the second space is in fluidic communication with the atmospheric environment.

36. The device according to clause 35, wherein when the absorbing element is inserted into the first space, the first space is sealed by an end portion with the absorbing element to form a sealed space.

37. The device according to clause 36, wherein when the absorbing element is inserted into the first space, the first space is sealed by an end portion with the absorbing element to form a sealed space; gas or liquid in the sealed space is compressed by the end portion to increase the pressure in the sealed space.

38. A method for detecting whether an analyte is present in a liquid sample, comprising: providing a first space for receiving an absorbing element, a second space containing a testing element, wherein fluidic communication between the first space and the second space is controlled by a controlling element.

39. The method according to clause 38, wherein a pressure in the first space is higher than a pressure in the second space such that the controlling element is opened automatically; a pressure in the first space is equal to a pressure in the second space such that the controlling element is closed automatically.

40. The method according to clause 39, wherein when the controlling element is opened automatically, gas or liquid located in the first space is capable of flowing into a second chamber to contact the testing element via the controlling element; or, when the controlling element is closed automatically, gas or liquid located in the first space is incapable of flowing into a second chamber via the controlling element.

41. A device for detecting whether an analyte is contained in a fluid sample, comprising:
a chamber, configured for receiving an absorbing element for absorbing the fluid sample;
a testing element located outside the chamber;
the chamber is communicated with the testing element via a channel;
and wherein when the absorbing element is inserted into the chamber, a scaled space where the absorbing element located therein is formed in the chamber; wherein a piston is arranged in the channel; the piston has a first state or a second state; when the piston is in the first state, the channel is sealed; when the piston or the valve is in the second state, the channel is opened wherein when a pressure in the sealed space is increased and is higher than a pressure of a space where the testing element is located therein, the increased pressure automatically enables the piston to change from the first state into the second state.

42. The method according to clause 41, wherein the absorbing element with the end portion is inserted into the first space such that the first space becomes a sealed space; the end portion moves in a first sealed space to compress the gas or liquid in the sealed space, thus increasing the pressure in the first space.

All patents and publications mentioned in the description of the present invention are disclosures of the prior art and they may be used in the present invention. All patents and publications referred to herein are incorporated in the references as if each individual publication is specifically referred to separately. The invention described herein may be practiced in the absence of any one or more of the elements, any one limitation or more limitations that are not specifically recited herein. For example, the terms “comprising”, “consisting of . . . substantively” and “consisting of . . . ” in each example herein may be replaced by the rest 2 terms. The so-called “a/an” herein merely means “one”, but does not exclude including 2 or more instead of including only one. The terms and expressions which have been employed herein are descriptive rather than restrictive, and there is no intention to suggest that these terms and expressions in this description exclude any equivalents, but it is to be understood that any appropriate changes or modifications can be made within the scope of the present invention and appended claims. It should be understood that, the embodiments described in the present invention are some preferred embodiments and features, and any person skilled in the art may make some changes and variations based on the essence of the description of the present invention, and these changes and variations are also considered to fall into the scope of the present invention and the independent claims and the appended claims.

1. A device for detecting an analyte in a fluid sample, comprising: an absorbing element configured for absorbing a fluid sample and a testing element configured for testing an analyte in the fluid sample; wherein a fluid communication between the testing element and the absorbing element is controlled by a controlling element.

2. The device according to claim 1, wherein whether the fluid communication between the testing element and the absorbing element is blocked or not is controlled by the controlling element.

3. The device according to claim 2, wherein when the controlling element is in a first state, the absorbing element is not in fluid communication with the testing element; and when the controlling element is in a second state, the absorbing element is in fluid communication with the testing element.

4. The device according to claim 3, wherein when the controlling element has an opened state and closed state; wherein when the controlling element is in a closed state, the absorbing element is not in fluid communication with the testing element; and when the controlling element is in an open state, the testing element is in fluidic communication with the absorbing element.

5. The device according to claim 4, wherein the opened state or closed state of the controlling element is automatically opened or automatically closed.

6. The device according to claim 5, wherein the controlling element is automatically opened or closed under the change of a liquid pressure or an air pressure between in a first space including the absorbing element therein and in a second space including the test element therein.

7. The device according to claim 6, wherein the pressure of the liquid or the pressure of the air in the first space is increased and is higher than the pressure of the second space, the increased pressure in the first space forces the controlling element being in the closed state to be in the open state.

8. The device according to claim 6, wherein the pressure is an air pressure; when the controlling element is forced by the air pressure, the controlling element is opened to exchange a gas between the first space and the second space.

9. The device according to claim 7, wherein the pressure is liquid pressure; when the controlling element is forced by the liquid pressure, the controlling element is opened to exchange the liquid between the first space and the second space.

10. The device according to claim 4, wherein the device further comprises a chamber configured to accommodate the absorbing element; when the absorbing element is located in the chamber, there is a pressure change between the chamber and a space where the testing element is located, and the pressure change enables the controlling element to be opened state or closed state automatically.

11. The device according to claim 10, wherein when the pressure in the chamber is higher than the pressure in the space, the increased pressure in the chamber enables the controlling element to be opened; or, when the pressure in the chamber is substantively equal to the pressure in the space, the controlling element is closed automatically.

12. The device according to claim 11, wherein the increase of the pressure in the chamber for accommodating the absorbing element is achieved by compressing a gas or a liquid in the chamber such that the pressure in the chamber is higher than the pressure of the space where the testing element is located.

13. The device according to claim 12, wherein the chamber is a sealed chamber.

14. The device according to claim 13, wherein the chamber is sealed by inserting the absorbing element into the chamber.

15. The device according to claim 14, wherein the air or the liquid in the sealed chamber is compressed by the absorbing element.

16. The device according to claim 7, wherein after or when the absorbing element is inserted into the first space, the space is sealed, and a gas or a liquid is compressed in the sealed first space as to increase the air pressure or liquid pressure.

17. The device according to claim 16, wherein the first space is located in a first receiving chamber, the first receiving chamber is located in a second receiving chamber, and the first receiving chamber is capable of moving in the second receiving chamber.

18. The device according to claim 17, wherein the air pressure or the liquid pressure in the first space is increased by the moving of the first receiving chamber in the second receiving chamber.

19. The device according to claim 18, wherein the second receiving chamber comprises a third receiving chamber; the third receiving chamber comprises a reagent for treating the liquid sample.

20. The device according to claim 3, wherein a first space including the absorbing element therein is connected to a second space including the testing element therein via a channel such that the fluidic communication between the first space and the second space is achieved by the channel, and wherein the controlling element is located in the channel.

21. The device according to claim 20, wherein the controlling element comprises a piston and a spring.

22. The device according to claim 21, wherein the piston has a first position and a second position in the channel; when the piston is in the first position, the channel is closed by the piston; when the piston is in the second position, the channel is opened by the piston.

23. The device according to claim 22, wherein when the spring is in a first state, the piston is in the first position by the rebound face applied by the spring; when the spring is in a second state, the piston is in the second position.

24. The device according to claim 23, wherein switching of the piston between the first position and the second position is achieved automatically by a change of a liquid pressure or an air pressure between the first space and the second space applied on the piston.

25. The device according to claim 24, wherein when the pressure on the piston is increased and is higher than the rebound force of the spring, the piston is located in the second position; and when the pressure on the piston is reduced and is less than or is equal to the rebound force of the spring applied on the piston, the piston is located in the first position.

26. The device according to claim 25, wherein when the piston is located in the second position, the channel is opened by the piston, thus gas or liquid is exchange between the first space and the second space.

27. The device according to claim 26, wherein the liquid or the air in the first pace is forced by the increased pressure in the first space to flows into the second space via the channel.

28. The device according to claim 27, wherein the liquid comprises a liquid sample or a liquid sample mixed with a treatment liquid.

29-83. (canceled)
